(19) United States
(12) Patent Application Publication
(10) Pub. No.: US 2022/0180634 A1
(43) Pub. Date: Jun. 9, 2022

(54) Method for Teaching Precision Body Movements and Complex Patterns of Activity

(71) Applicant: Full Court Tennis, LLC

(72) Inventor: Brian Teacher, Pasadena, CA (US)

(21) Appl. No.: 17/541,811

(22) Filed: Dec. 3, 2021

Related U.S. Application Data
(60) Provisional application No. 63/199,077, filed on Dec. 4, 2020.

(51) Int. Cl. G06V 20/40; G06V 20/70; G06V 40/20; A63B 24/00

(52) U.S. Cl. CPC G06V 20/41; G06V 20/70; G06V 40/20; A63B 2024/0068; A63B 24/0062; A63B 2024/0012; A63B 24/0006

(57) ABSTRACT

Disclosed is a computer-implemented method for educating subjects on the performance of elemental movements or series of movements within a set of precision body movements or complex patterns of activity.

### CROSS REFERENCE TO RELATED APPLICATIONS

This application claims priority to Provisional Application Ser. No. 63/199,077 filed on Dec. 4, 2020 and entitled “Method and Apparatus for Teaching Precision Body Movements and Complex Patterns of Activity,” the contents of which is fully incorporated herein for all purposes.

### BACKGROUND OF THE INVENTION

### Field of the Invention

The present invention relates to a computer-implemented method and apparatus for educating subjects on the performance of elemental movements or series of movements within a set of precision body movements or complex patterns of activity. The method and apparatus overcome the generic nature of prior art teaching methods and apparatuses by analyzing a subject's unique EmperioKine-Alysi and comparing the subject's unique EmperioKine-Alysi to a reference EmperioKine-Alysi of one or more highly elite performers having the same or similar performance parameters as applied to an Etozi-Etakmos of said precision body movements or complex patterns of activity.

### Background of the Invention

Precision body movements and complex patterns of activity, whether they be athletics, fighting sports or skills, dance, physical performance or exercise involve the interaction of muscular and skeletal components across the entirety of the kinetic chain, as well as the efficient transfer of potential energy to kinetic energy through proper body loading and through systematic coiling and uncoiling.

Kinetic chain efficiency in the execution of an Etozi-Etakmos requires that muscular and skeletal components flow simultaneously and serially according to specific techniques along certain vectors. Efficient techniques vary, depending on certain performance parameters of the individual conducting the activity.

Several different methods exist to teach the proper mechanics of sports and various athletic motions including, but not limited to, swinging a golf club, tennis racket, or baseball bat. One method of teaching includes the assessment of a subject through observation using video analysis. The typical video analysis system captures the subject's movements by means of a video-recording or digital device. An instructor observes the recording of the subject's movements and provides subjective analysis and instruction. Film study, as the most widely used video analysis method is generally referred to, has been recognized as a valuable tool for teaching proper mechanics. This method allows the instructor to show the subject, by means of video recordings of the subject's movements, problematic movements as well as to offer advice on how to correct those problems in order to achieve proper mechanics.

Although widely used, traditional video analysis systems have limitations. One limitation of video analysis systems relates to the subjectiveness of the instructor providing the analysis. Another limitation of video analysis systems relates to the quality of the instruction, in that it is limited to only those areas which the instructor recognizes and addresses. If an instructor fails to observe a given problematic movement, or does not recognized said movement as being problematic, it is axiomatic that the subject will not be instructed on how they may improve that movement.

Video analysis is also limited by the instructor's ability to effectively communicate the problem as well as the solution to the subject. Instruction that is not understood, whether the misunderstanding is in defining the problematic movement or in defining the solution to the problematic movement, will not result in improved behavior.

Another limitation of video analysis is related to the quality and comprehensiveness of the video capture system. Typically video analysis systems consist of one or more fixed or semi-fixed cameras recording a performance or series of movements within a given time period. For example professional tennis matches routinely have five, or more, cameras trained on the match. As players move up and down the court, field, ice or stage, moving forward and back, side-to-side, twisting, turning, jumping, kneeling, sliding, the cameras are routinely out-of-position. In other words, video capture systems are not capable of ensuring that there is always a camera properly positioned in the optimal spot to fully record the subject's mechanics and motions as they progress through each of the Etozi-Etakmos, or unique elemental movements, associated with a performance or series of movement, in order for an instructor to properly and fully isolate each Etozi-Etakmos and be able to play it back for the subject.

For these reasons, as well as others, traditional video analysis is subjective, prone to inaccuracy and the quality of their educational benefits vary widely by subject, instructor, and system capabilities, as well as from lesson-to-lesson.

Another method of analyzing and improving the performance of athletic movements are data acquisition systems. Data acquisition systems use sensor technology to monitor and analyze certain movements and or performances. The prior art teaches of data acquisition systems including: GB 2006/2417908A which discloses a “golf training device for improving a subject's address of a golf ball”; EP 2007/1810724A1 which discloses a “golf diagnosis apparatus, comprising an evaluation unit for evaluating a quality of a stroke of a golf player”; US 2002/6402635 B1 which discloses “[a]n apparatus for measuring ground reaction forces and various weight shifts”. These and other motion analysis systems require that the subject wear sensor elements or reflective tape on their body and/or on their equipment. The sensor elements transmit positional data of various body parts, such as legs, hips, shoulders, hands and head during the course of the movement. One benefit of these systems is that they are adept at data acquisition.

One of the limitations of data acquisition systems is that they do not provide high quality visualization, as compared to video analysis systems. Early inventive systems provided crude “stick figure” animation. More recent inventive systems provide digital animation depicting elements of a movement based upon captured data. Digital animation, particularly a digital avatar of a subject, can distract the subject from the lessons being taught, as the subject focuses on how their image translated into the digital medium, rather than the content.

Another limitation of data acquisition systems is the observer-expectancy effect. Observer-expectancy effect is a form of reactivity in which a researcher's cognitive bias causes them to subconsciously influence the participants of an experiment. Additionally, knowing that they are being observed and recorded, wearing sensors and reflective tape makes the subject conscious of the process, alters the weight, balance feel of a racket, club, ball or garment introduces a bias in how the outcome is assessed.

Another limitation of data acquisition systems is that these systems do not compare the subject's movements to those of an individual with comparable parameters performing at a highly elite level, or the highest known level. These systems compare the subject's movements to the subject's prior performances, or those of a theoretical digital avatar, or a computer generated archetype, or a quintessential performer. This type of analysis sets unrealistic expectations that can have a boomerang effect, discouraging the subject or harming their psyche.

What is needed is a video analysis system that compares subjects to highly elite performers, performing each of the Etozi-Etakmos of the activity being analyzed, with a means for objectively comparing the subject's performance of each Etozi-Etakmos observed to an objective analysis of the performances of said highly elite performer that, for the purposes of instruction, is alike in all relevant ways. What is also needed is a way to augment, enhance, and annotate videos in a way that overcomes the limitations of traditional video analysis without introducing known biases.

It is with respect to these and other considerations that the present invention has been made.

### SUMMARY OF THE INVENTION

The inventive method consists of reducing the universe of all body movements and activities within a set of precision body movement or complex pattern of activity into the elemental Etozi-Etakmos necessary to effectively teach a subject how to master said precision body movement or complex pattern of activity. The method further consists of having an education means to evaluate a live, recorded, reproduction or broadcast made digitally or videotape of a subject's performance, analyzing subject's EmperioKine-Alysi within each of the Etozi-Etakmos observed during said performance or series of movements by comparing subject's movements to a reference set of Etozi-Etakmoses, objectively analyzed for EmperioKine-Alysi, of one or more highly elite performers that, in all relevant ways for the purposes of instruction, is comparable to the subject.

The apparatus comprises a computer network, a public communication network connected to said computer network and a user operated device capable of accessing said computer network. It also includes a means for users to upload videos of performance or series of movements of subjects performing one of more Etozi-Etakmoses and a means for objectively analyzing said Etozi-Etakmoses. It also includes a video archive of highly elite performers (“Pro Videos”), performing each of the Etozi-Etakmoses or, elemental movements of the activity, objectively analyzed for EmperioKine-Alysi.

It also includes a means of instructional access to the computer network. Said instructional access made be from a terminal or device within the computer network or via a public communications network. Instructional access includes a means for objectively analyzing subject's EmperioKine-Alysi within each of the Etozi-Etakmos depicted in the uploaded videos of the subject against the Pro Video Etozi-Etakmos, objectively analyzed for EmperioKine-Alysi, of a highly elite performer that, in all relevant ways for the purposes of instruction, is comparable to the subject.

It may also include a means for digitally enhancing the video by means of three-dimensional (3D) representation and visualization. Said 3D images can be used to recreate a dynamic scene or visualize other viewpoints besides the one that video actually captured, or to reproduce the sensation of three dimensions. The insertion of depth into video analysis allows it to be more readily absorbed by the human perceptual system. It may also include a means for educators, or machine learning and AI tools, to objectively extract high-level information, rapidly and precisely. It may also include 3D images or model based digital enhancements which allow scene visualization from all viewpoints.

It may also include a means of instruction including, but not limited to, conditioning and training exercises, drills, written materials, visualizations, charts, diagrams, processes, strategies, mnemonic or any other appropriate learning aid.

These and many other objects and advantages of the present subject matter will be readily apparent to one skilled in the art to which the invention pertains from a perusal of the claims, the appended drawings, and the following detailed description of preferred embodiments.

### BRIEF DESCRIPTION OF THE DRAWINGS

FIG. 1 provides a flowchart of the inventive system workflow illustrating: 100 Determining Elemental Etozi-Etakmos; 200 Defining EmperioKine-Alysi for each Elemental Etozi-Etakmos; 300 Defining EmperioKine-Alysi Parameters; 400 Uploading and Segmenting Pro Video; 500 Defining Reference Etozi-Ektamos; 600 Uploading and Segmenting Subject Video; 700 Determining Subject Etozi-Etakmos; 800 Determining Subject EmperioKine-Alysi Parameters; 900 Determining Pro Videos with Subject EmperioKine-Alysi Parameters; 1000 Analyzing Subject EmperioKine-Alysi Against Pro Videos; 1100 Evaluating EmperioKine-Alysi of each Subject Etozi-Etakmos; 1200 Comparing and Contrasting Etozi-Etakmos of annotated Subject videos to Pro Videos; 1300 Presenting and Informing illustrating; 1400 Instruction.

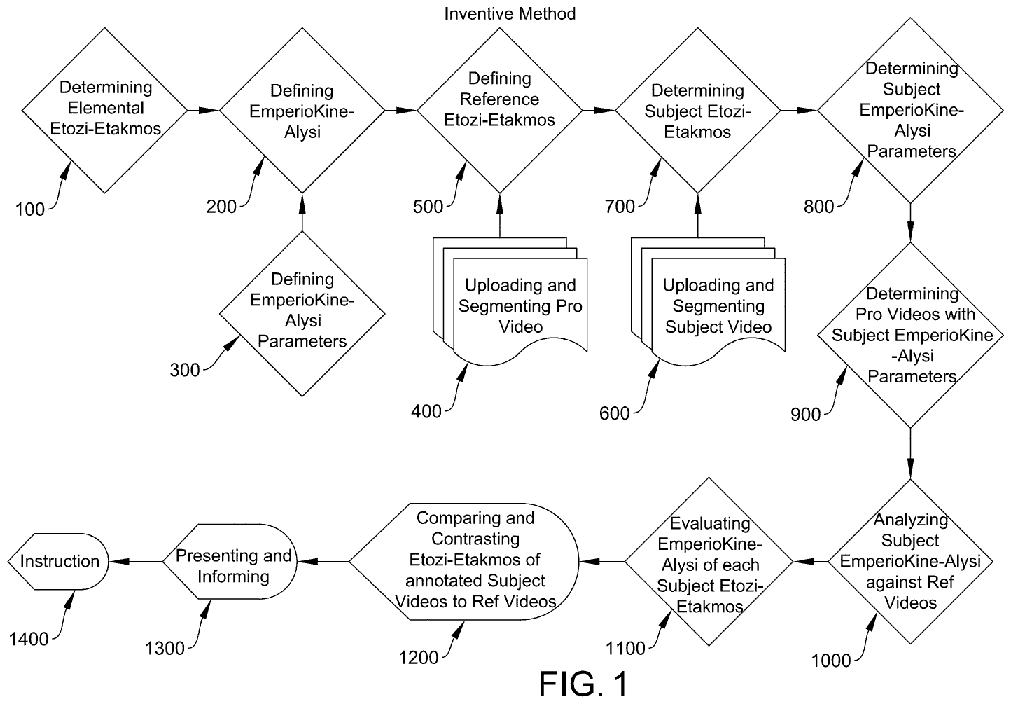

FIG. 2 provides a flowchart of the step of 100 Determining Elemental Etozi-Etakmos illustrating: 110 Defining universe of all body movements and activities; 120 Reducing the universe of all body movement and activities to Elemental Etozi-Etakmos; 130 Establishing the Ready-Response-Execution-Recovery-Ready Paradigm for each of the Elemental Etozi-Etakmos; 140 Establishing the Kinetic Chain across each Etozi-Etakmos; 150 Determining the parameters affecting Etozi-Etakmos; 160 Applying Various parameters to Etozi-Etakmos; and, 170 Defining determinative Etozi-Etakmos Parameters/Parameter Groupings.

FIG. 3 provides a flowchart of the step of 200 Defining EmperioKine-Alysi for each Etozi-Etakmos illustrating: 210 Defining unique kinetic chain elements of each Etozi-Etakmos; 220 Applying determinative Etozi-Etakmos parameter/parameter groupings to each unique kinetic chain elements; 230 Defining universe of EmperioKine-Alysi; 240 Analyzing the universe of EmperioKine-Alysi for definitive groupings, and 250 Segmenting definitive groupings of EmperioKine-Alysi by age, ranking, skills, maturity and improvement potential of subject.

FIG. 4 provides a flowchart of the step of 300 Defining EmperioKine-Alysi Parameters illustrating: 310 Definitive groupings of EmperioKine-Alysi segmented by age, ranking, skills, maturity and improvement potential of Pro Videos; 320 Segment by definitive parameter/parameter groupings; 330 Applying most impactful parameters/parameter groupings; 340 Applying Performance Factors; 350 Define reference EmperioKine-Alysi; and, 360 Defining Supplemental EmperioKine-Alysi.

FIG. 5 provides a flowchart of the step of 400 Uploading and Segmenting Pro Videos: 410 Assembling a library of highly elite performers engaged in the activity; 420 Segmenting Pro Videos by Defined Pro Video Etozi-Etakmos; 430 Segmenting Pro Videos by definitive parameters; and, 440 Segmenting Pro Videos by parameter groupings.

FIG. 6 provides a flowchart of the step of 500 Defining Pro Video Etozi-Etakmos illustrating: 510 Defining universe of all Pro Video body movements and activities; 520 Reducing Universe of all Pro Video body movements and activities to Elemental Etozi-Etakmos; 530 Establishing Pro Video Ready—Response—Execution—Recovery—Ready Paradigms, 540 Establishing Kinetic Chain across Pro Video Etozi-Etakmos; 550 Applying Various Parameters to Pro Video Etozi-Etakmos; 560 Determining parameters affecting Pro Video Etozi-Etakmos; 570 Defining Pro Video determinative Etozi-Etakmos/Parameter Groupings.

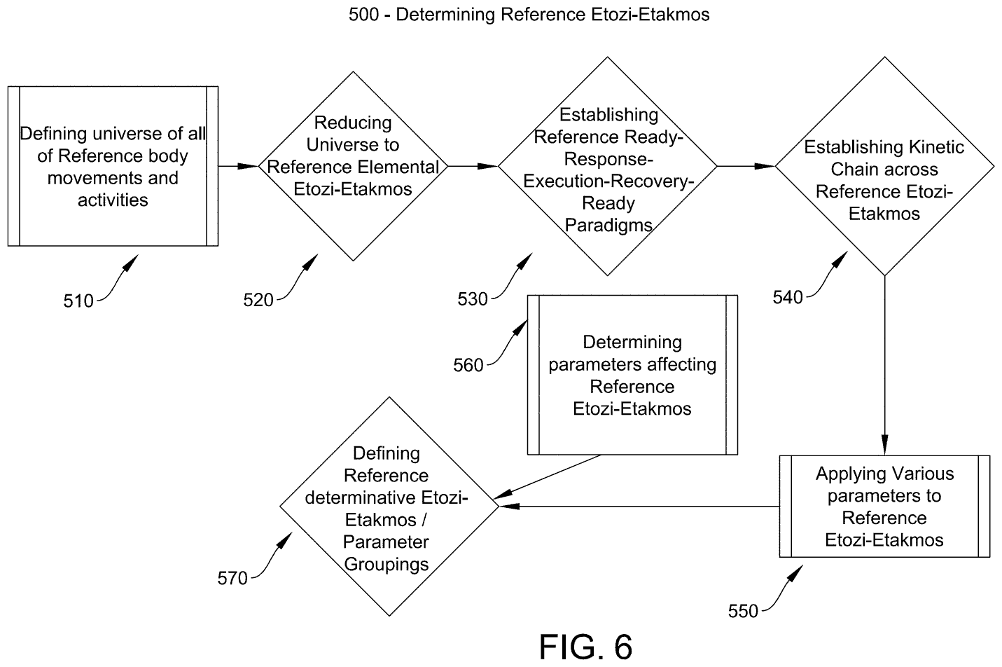

FIG. 7 provides a flowchart of the step of 600 Uploading and Segmenting Subject Videos illustrating: 610 Assembling library of subject engaged in the activity; 620 Segmenting subject's videos by Defined Pro Video Etozi-Etakmos; 630 Segmenting subject's videos by definitive parameter; and, 640 Segmenting subject's videos by parameter groupings.

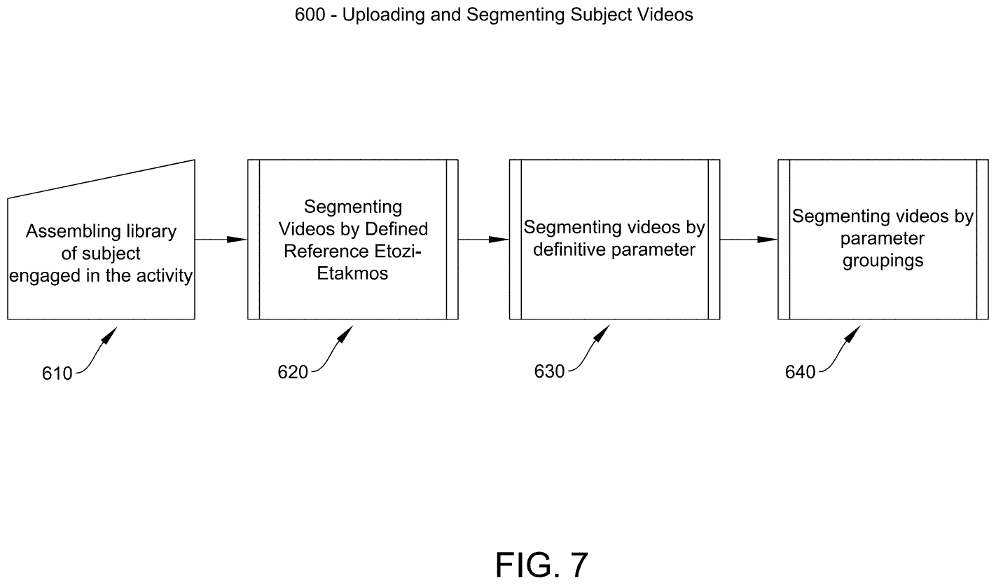

FIG. 8 provides a flowchart of the step of 700 Determining Subject's Etozi-Etakmos illustrating: 710 Defining universe of all of Subject's body movements and activities; 720 Reducing universe of all of Subject's body movements and activities to Subject's elemental Etozi-Etakmos; 730 Establishing Subject's Ready—Response—Execution—Recovery—Ready Paradigms; 740 Establishing Kinetic Chain across Subject's Etozi-Etakmos; 750 Applying various parameters to subject's Etozi-Etakmos; 760 Determining parameters affecting subject's Etozi-Etakmos; and, 770 Defining subject's determinative Etozi-Etakmos/Parameter Grouping.

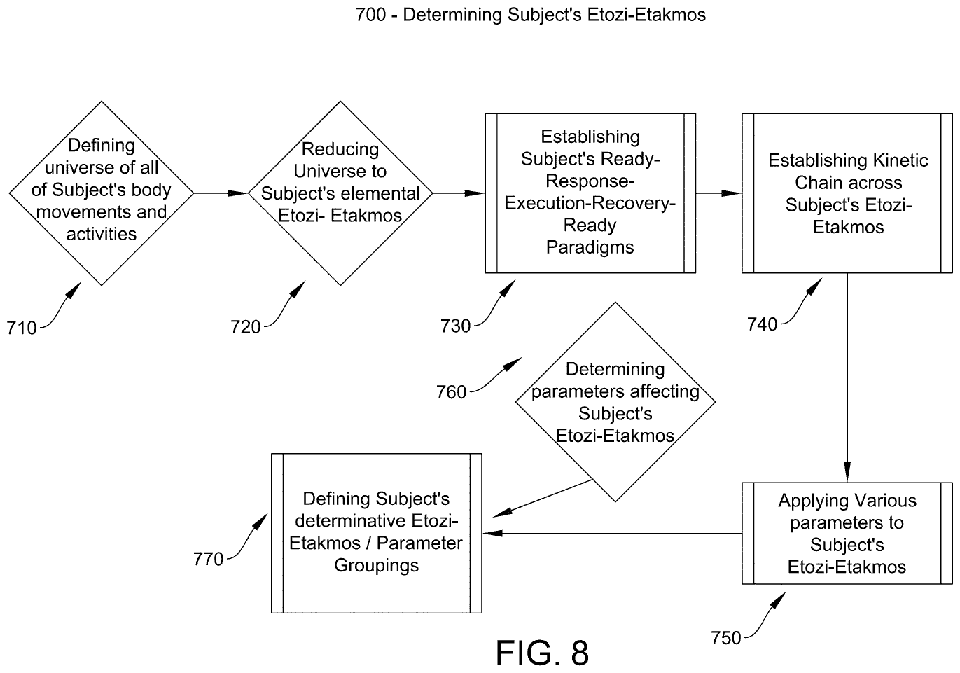

FIG. 9 provides a flowchart of the step of 800 Defining subject's EmperioKine-Alysi parameters illustrating: 810 Definitive groupings of video of subject's EmperioKine-Alysi segmented by subject's age, ranking, skills, maturity and improvement potential; 820 Segmenting said videos by subject's definitive parameter groupings; 830 Applying Subject's most impactful Parameters; 840 Applying Subject's age, ranking, skills, maturity and improvement potential to said videos; 850 Defining subject's EmperioKine-Alysi; and, 860 Defining subject's Supplemental EmperioKine-Alysi, if any, for each Etozi-Etakmos depicted in said videos.

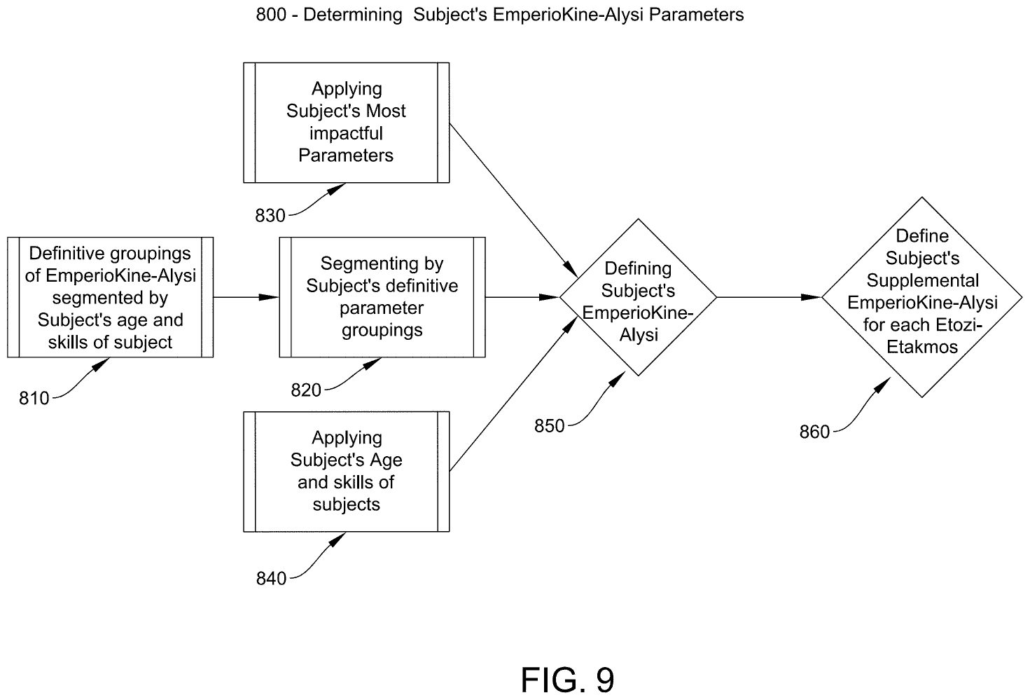

FIG. 10 provides a flowchart of the step of 900 Determining Pro Videos with subject's EmperioKine-Alysi Parameters illustrating: 910 Comparing subject's EmperioKine-Alysi parameters and Supplemental EmperioKine-Alysi parameters to Pro Videos; and, 920 Annotating Resultant Pro Videos.

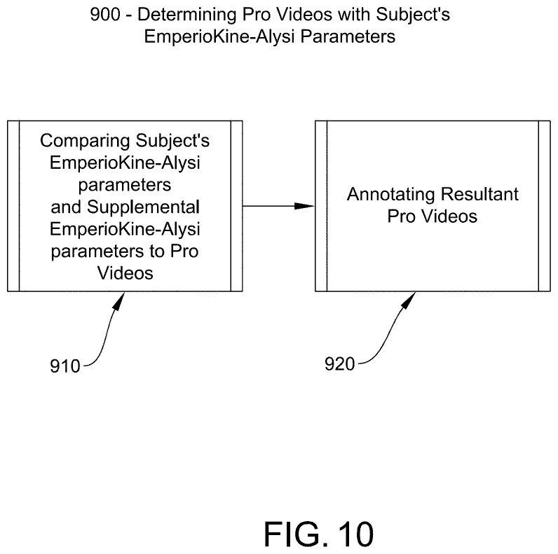

FIG. 11 provides a flowchart of the step of 1000 Analyzing Subject's EmperioKine-Alysi Parameters Against Pro Videos illustrating: 1010 Comparing subject's videos to annotated Pro Videos; and, 1020 Analyzing each Etozi-Etakmos against Etozi-Etakmos of annotated Pro Videos.

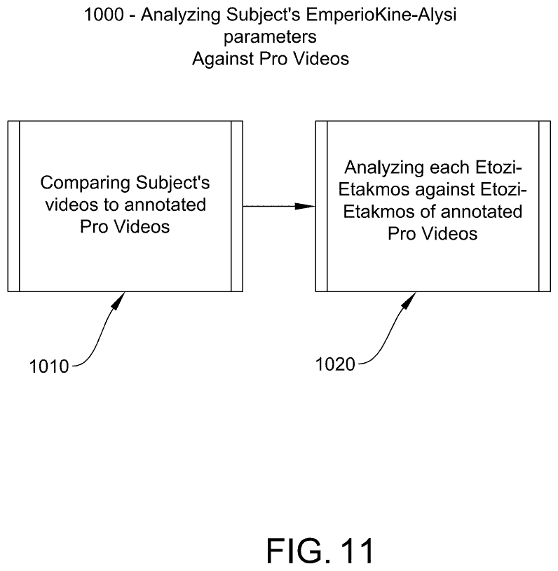

FIG. 12 provides a flowchart of the step of 1100 Evaluating EmperioKine-Alysi of each subject Etozi-Etakmos illustrating: 1110 For each Etozi-Etakmos analyzed in step 1000, breaking down each Etozi-Etakmos into component parts; 1120 Evaluating the EmperioKine-Alysi of each component part of the Etozi-Etakmos by key body parts within each movement; and, 1130 Annotating the movement of each key body part along the relevant plane of motion.

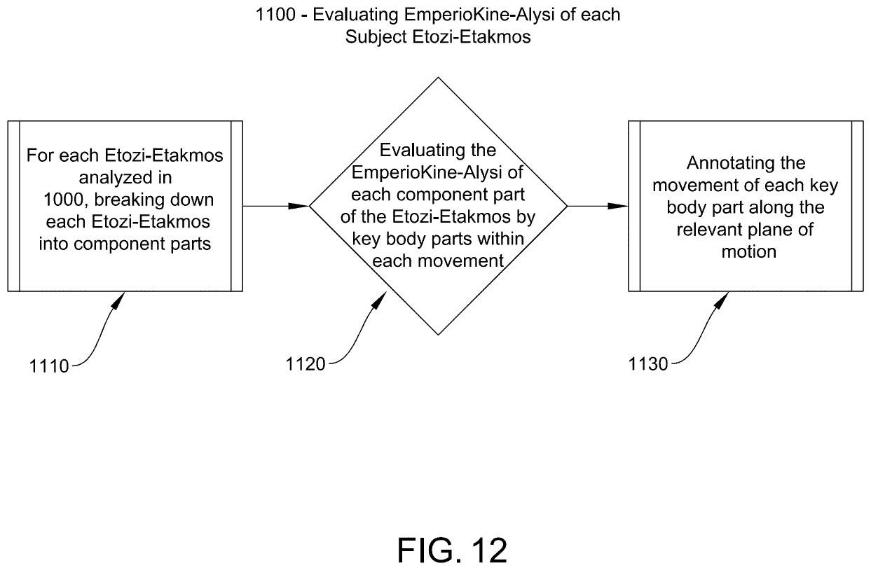

FIG. 13 provides a flowchart of 1200 Comparing and Contrasting Etozi-Etakmos of annotated Subject videos to Pro Videos illustrating: 1210 For each Etozi-Etakmos analyzed in Step 1100, breaking down each Etozi-Etakmos into component parts of the movement; 1220 Evaluating the EmperioKine-Alysi of each component part of the movement by key body parts within each Etozi-Etakmos; and, 1230 Annotating component parts of the movement of each key body part along the relevant plane(s) of motion.

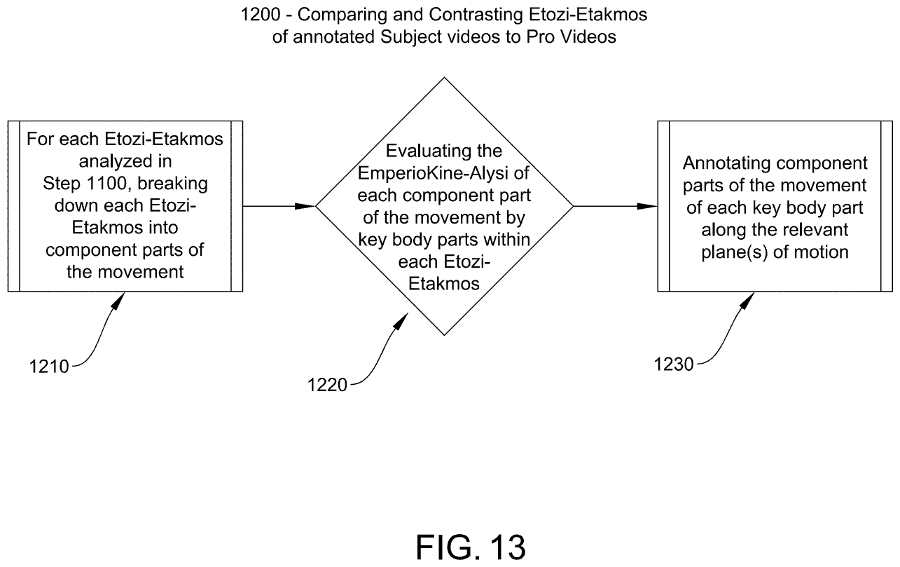

FIG. 14 provides a flowchart of 1300 Presenting and Informing illustrating: 1310 For each video annotated in Step 12, presenting a Pro Video of comparable movements; and 1320 Educator informing subject as to strengths weaknesses and areas needing improvement.

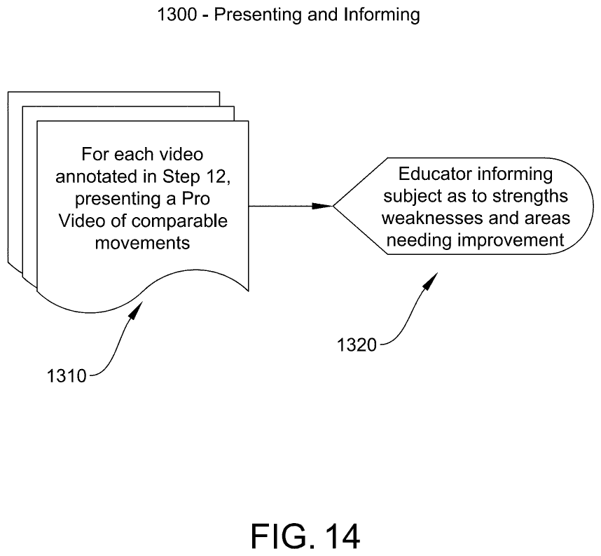

FIG. 15 provides a flowchart of 1400 Instruction illustrating: 1410 For each area needing improvement defined Step 13, Education Means provides instruction for improvement; and, 1420 Education Means further providing a method for implementation of instruction.

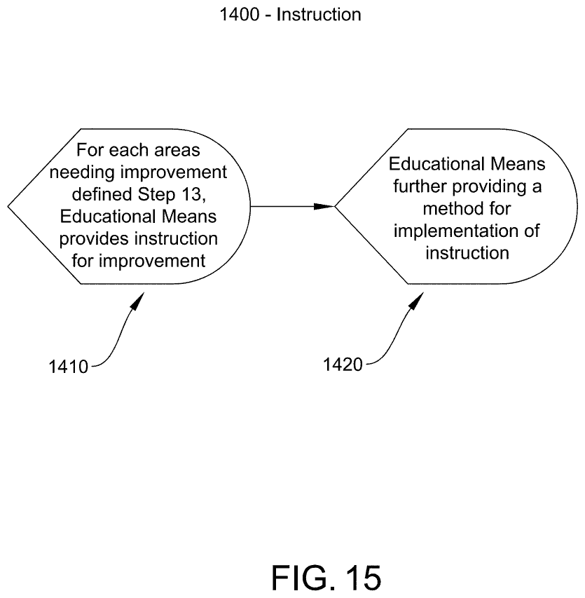

FIG. 16 provides a schematic view of 1500 Cloud-Based Computer Network illustrating: 1510 wired device(s) accessing 1530 cloud-based networking resources and services; 1520 wireless device(s) accessing 1530 cloud-based networking resources and services; 1530 cloud-based networking resources and services; 1540 Private network device connected to 1530 cloud-based networking resources and services; 1550 Private network wireless device connected to 1530 cloud-based networking resources and services; and, 1560 data repository.

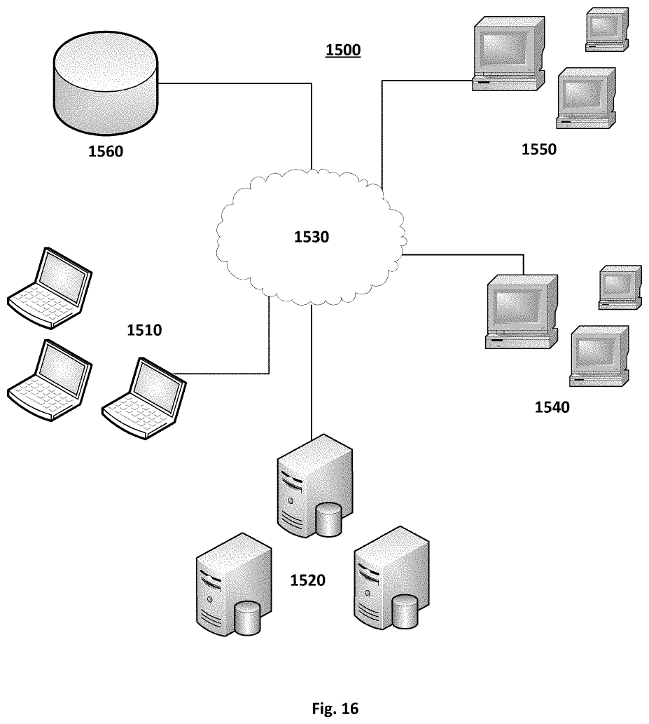

FIG. 17 provides a system schematic of 1600 Cloud-Based Computer Network illustrating: 1605 Data Submission means; 1610 Input Data Processing System; 1615 Routing Engine; 1620 Video Processing; 1625 Empeiro-Kinalysi Analytics; 1630 Etozi-Etakmos Analytics; 1635 Routing Engine 1640 Education Analytics 1645 Business logic, Presentation tools, Instructional requirements, and supplemental data, 1650 Instructional database 1655 training, drills, materials; 1660 network of private servers; and 1665 Staff/Members, Educational Means and Analysts accessing private server network.

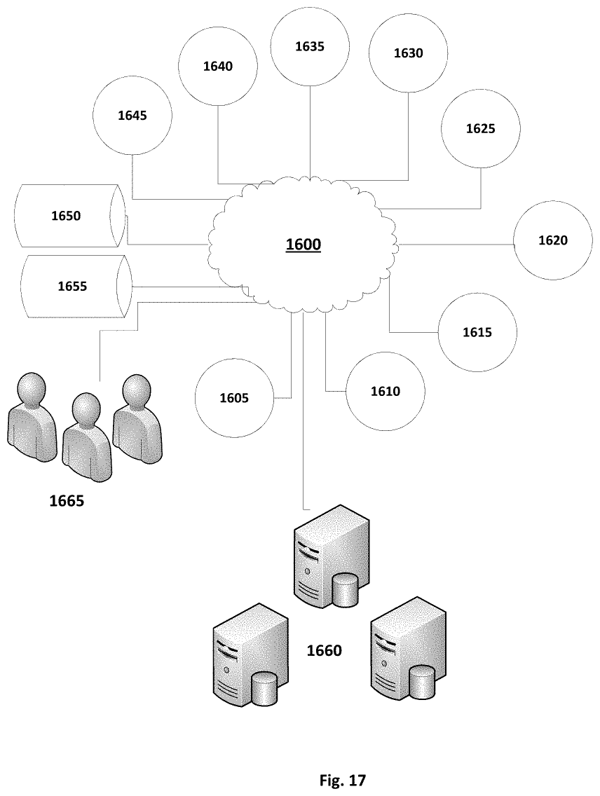

FIG. 18 illustrates a blown up view of one embodiment of 1700 vector analysis of a Etozi-Etakmos for the sport of tennis.

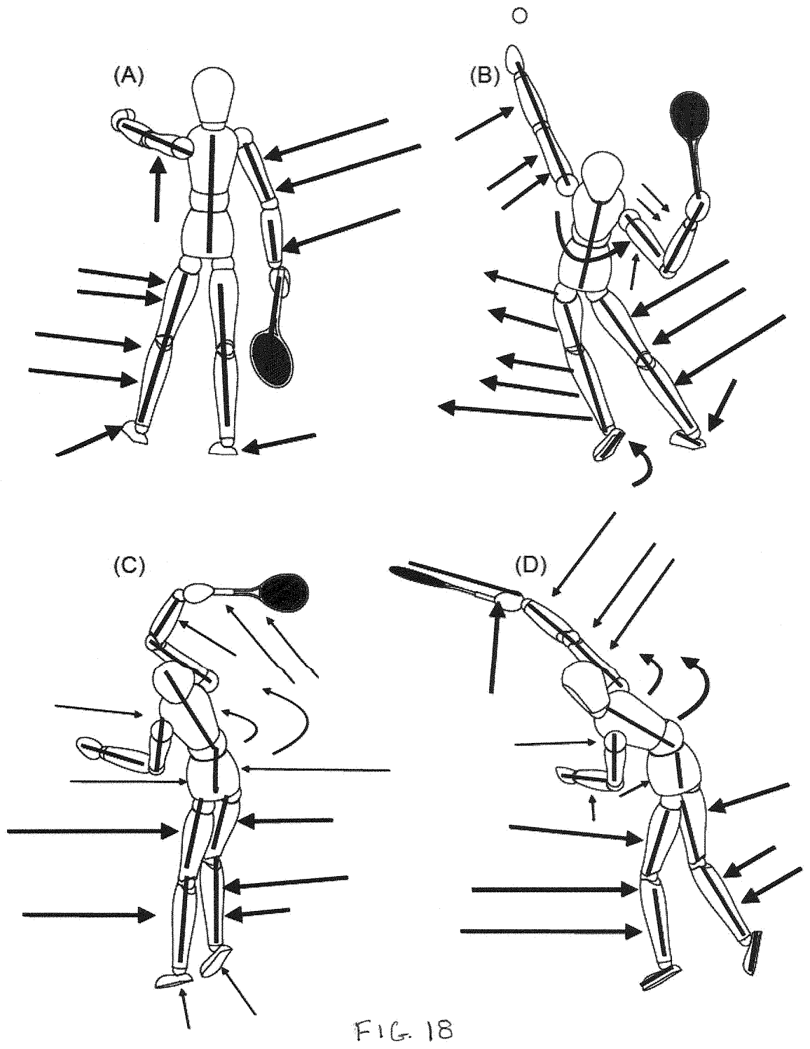

FIG. 19 provides an overhead view of one embodiment of 1800 vector analysis of a Etozi-Etakmos for the sport of Boxing.

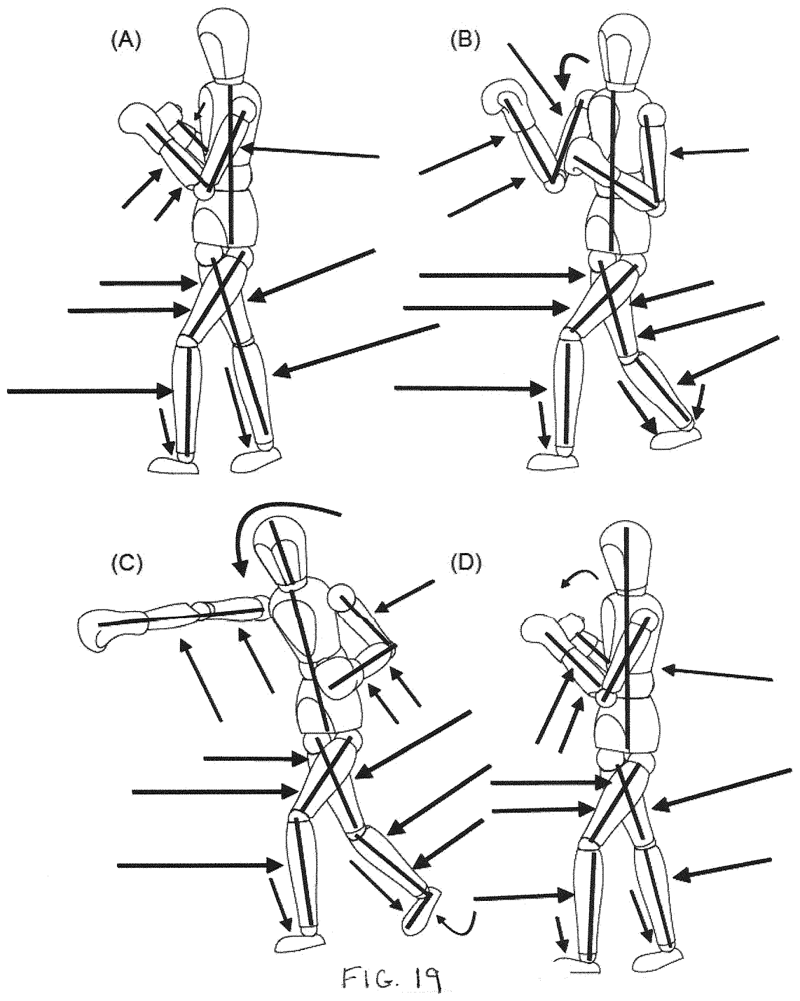

FIG. 20 is a perspective view of one embodiment of 1900 vector analysis of a Etozi-Etakmos for the sport of track and field.

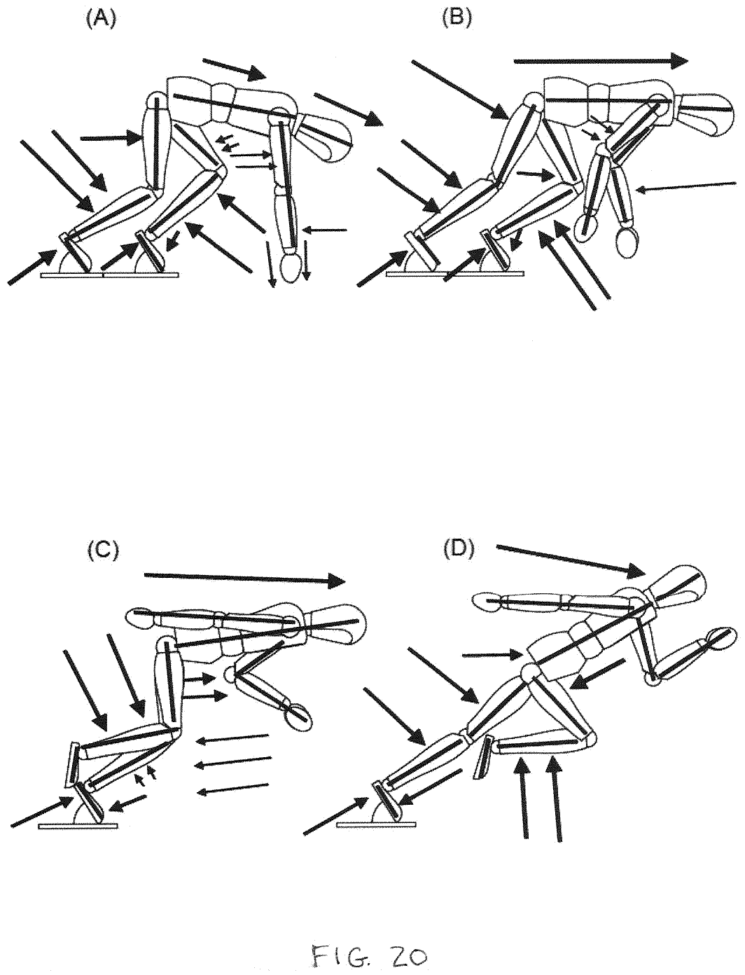

FIG. 21 is a perspective view of one embodiment of 2000 vector analysis of a Etozi-Etakmos for the activity of Ballet.

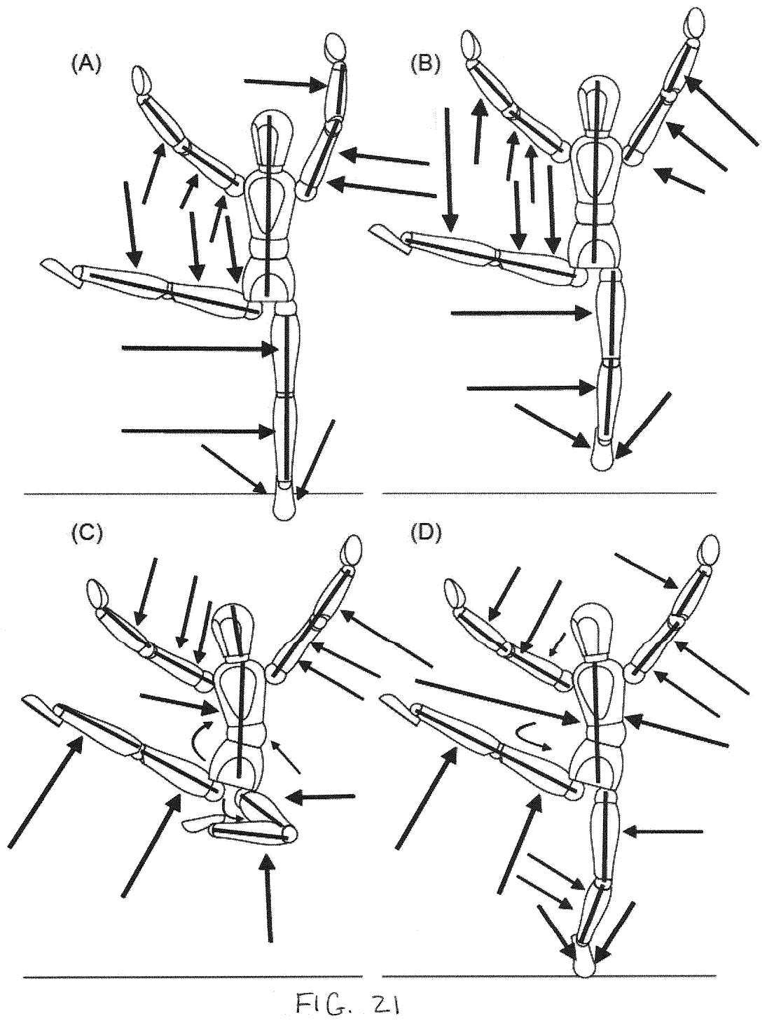

FIG. 22 is a diagrammatic view of one particular embodiment of the present disclosure for use in teaching tennis.

### DETAILED DESCRIPTION

The following detailed description is merely exemplary in nature and is in no way intended to limit the scope of the invention, its application, or uses, which may vary. The invention is described with relation to the non-limiting definitions and terminology included herein. These definitions and terminology are not designed to function as a limitation on the scope or practice of the invention but are presented for illustrative and descriptive purposes only.

Various terms used throughout the specification and claims are defined as set forth below as it may be helpful to an understanding of the invention.

As used herein an “Education Means” includes, but is not limited to, a person, e.g., coach, teacher, one skilled in the movement or activity, or an electronic process, e.g., an algorithm, artificial intelligence or machine learning, capable of recognizing a unique Etozi-Etakmos within a performance or series of movements and comparing said Etozi-Etakmos to a Pro Video Etozi-Etakmos.

As used herein “Precision Body Movements and Complex Patterns of Activity” refer to a subject using their own body as the medium to execute an Etozi-Etakmos or series of Etozi-Etakmos to complete an activity, including but not limited to athletics, fighting sports or skills, dance, physical performance, for the purpose of competition, expressing an idea or emotion, releasing energy, accomplishing work, or simply taking delight in the movement itself.

As used herein “Etozi-Etakmos” shall mean the smallest unit of the kinetic chain progression of compound movements within a larger universe of body movements or activities. In one implementation of the invention, Etozi-Etakmos includes the execution of an elemental kinetic chain progression within said precision body movements and complex patterns of activity.

As used herein “Performance parameters” shall mean a numerical or other measurable factor or characteristic that is useful, or critical when defining or analyzing the Etozi-Etakmos and/or EmperioKine-Alysi of a subject, or when evaluating said subject's performance, status or condition.

As used herein “EmperioKine-Alysi” shall mean the effective, efficient and proprioceptic interaction of muscular and skeletal components across the entirety of the kinetic chain, as well as the efficient transfer of potential energy to kinetic energy through proper body loading and through systematic coiling and uncoiling to perform various Etozi-Etakmos associated with Precision Body Movements and Complex Patterns of Activity at a highly elite level, consistently and repetitively.

As used herein “Kinetic Chain” shall mean various interconnected body parts moving in unison, such as feet-legs-hips, shoulders, arm-forearms wrist-head, during the course of an Etozi-Etakmo.

As used herein “Elemental Kinetic Chain Progression” shall mean sequenced physiologic muscle activations in the kinetic chain resulting in an integrated biomechanical task of an Etozi-Etakmos.

As used herein “Full-Body Kinematics” shall mean the system of establishing and monitoring the initial conditions of any known values of position, velocity and/or acceleration of a subject's kinetic chain during an Etozi-Etakmos.

As used herein “Vector Analysis” shall mean to scrutinize movements of a performance or activity for the purpose of causing a change of proficiency within the movement or activity but that does not constitute a complete movement or activity itself. Vector analysis shall include investigating correct movement patterns including, but not limited to, the Ready position, the Approach, the Execution, and Recovery; Movement velocity; Core stability, Movement Force, and, Recovery.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

General

As indicated above, this invention describes (among other things) a computer-implemented method for quickly teaching precision body movements or complex pattern of activity to a subject. Precision body movements or complex patterns of activity include, but are not limited to sports and athletics, fighting sports or skills, dance, physical performance, and various athletic motions for the purpose of competition, expressing an idea or emotion, releasing energy, accomplishing work, or simply taking delight in the movement itself (“Specific Discipline”). Among other things, this invention describes a method of segmenting all movements and patterns of an activity by Etozi-Etakmos, the elemental movements or series of movements required to quickly master the sport, athletics, etc. This invention also describes a method of comparison of the user's performance to that of highly-elite performer(s) having similar performance parameters including but not limited to age, height, weight, strength, skills, ranking, etc. Among other things, the invention describes a method for virtual cloud-based instruction and education whereby a user can upload a video or digital representation of a performance for objective analysis and comparison by one skilled in the art, i.e. an coach or instructor, against a reference video or videos. The objective analysis centers around analyzing the subjects; unique kinetic chain efficiency, or “EmperioKine-Alysi”. It also provides various means of coaching and instruction including live instruction, split screen instruction, pre-recorded instruction, training, exercises, drills and materials.

Etozi-Etakmos

Kinesiology is the study of the principles of mechanics and anatomy in relation to human movement. Exercise Science is the study of human movement and the changes caused by physical activity in the body with the goal of understanding how to maintain or improve health and fitness. The present invention provides a method for objectively studying body movements, responses and adjustments in relation to a Specific Discipline.

Etozi-Etakmos is a method for objectively applying the principals of Kinesiology and Exercise Science in relation to a specific discipline. For any repetitive precision activity or complex pattern of movement associated with a Specific Discipline, there are certain unique elemental movements, that need to be mastered or are repeated throughout the activity. These Elemental Kinetic Chain Progressions may be building blocks for more complex movements (like phonemes are to a language) or they may be the basic movements (words of a language) that are repeated throughout (to communicate a thought or message), including, but not limited to a, jab, hook, throw, fore-hand, serve, jump shot, arabesque, pas de bourrée couru, nage waza or ateme waza. Said elemental movements are the Etozi-Etakmos for their respective Specific Discipline(s).

In order to ensure that the analysis is objective, the inventive method provides an education means for analyzing a subject's mechanics and motions as they progress from the completion of one Etozi-Etakmos, or ictum or movement, up to and including the start of next Etozi-Etakmos. Each such Elemental Kinetic Chain Progression or, ictum, is further segmented into biomechanical and psychological stances that the subject transitions through in executing the Etozi-Etakmos. In the preferred embodiment, these biomechanical and psychological stances are subdivided along the Ready-Response-Execution-Recovery-Ready paradigm. In another embodiment it may be subdivided by Execution-Recovery paradigm.

In the preferred embodiment, the “Ready” position is the biomechanical and psychological stance that the subject adopts immediately prior to the execution of an Etozi-Etakmos and at the completion of said Etozi-Etakmos. In this embodiment, the Ready represents the having gone full-circle through the movement.

In one embodiment, the biomechanical stance at the Ready addresses body positioning, including but not limited to weight distribution: front toe—back heel, shoulder to shoulder; feet position and width; an elbow's vertical height, medial lateral position and width, breathing. Similarly, the psychological stance may include factors related to preparing for the subjects next move, anticipating an opponent's next move, staying grounded in the moment, or running through a mental progression or check list of “What ifs.”

In one embodiment, the Ready in tennis may include the proper position for the subject to adopt against a specific competitor or characteristics of a competitor when preparing to return a service or recovering from a left-handed back hand, hit deep in the right side of the court. It may also include a mental progression that considers the score, the opponents serving skills and whether or not it's a first attempt or second at a serve.

In another embodiment, the Ready in figure skating it may be a subject gathering enough speed to execute an “Axel” jump. It may include consideration for the foot they will push off on, the place they the jump begins as well as where it will end.

In yet another embodiment, the Ready in baseball may be the position and mental progression or checklist a second baseman adopts with a man on first base, with one out. In this embodiment, his or her mental progression may include his response of the ball is hit to him: catching the ball on the outside of his glove, tossing the ball to the short-stop, under handed, and ducking to avoid getting hit by the ball when short stop throws the ball to the first baseman, to “turn the double play.”

In the preferred embodiment, the “Response” addresses the biomechanical and psychological progression that the subject goes through to determine the Etozi-Etakmos they intend to deploy and how they prepare for it. In one embodiment, the Response may include the systematic coiling of the Kinetic Chain, i.e. bending one's knees; leaning forward on the balls of one's toes, elbows up, and racket back.

In another embodiment, the Response may be to position one's body in such a way to prevent an opponent from moving in that direction. For example a Cornerback in football may turn their hips is such a direction as to prevent the opposing team's wide-receiver from easily running to the inside of the Cornerback.

In another embodiment, the Response maybe to position one's hands on the shoulders or arms of an opponent. One the Response in figure maybe be to place one's hands around the waist of one's partner while straightening one's arms, slowing down and bending one's knees and shifting one's weight to one's heals.

In yet another embodiment, the Response maybe to position one's hands on the shoulders waste of a partner. One the Response in Judo may be to prepare to throw or unbalance an opponent.

In the preferred embodiment, the “Execution” addresses the biomechanical coiling and uncoiling of the particular parts of the body to achieve power, speed, agility and effect, while maintaining balance and control that the subject goes through in the execution of an Etozi-Etakmos. In one embodiment, the Response may include the systematic uncoiling of the kinetic chain: straightening of one's knees; taking a step forward, transferring the energy coiled in one's muscles into kinetic energy; the lateral, proximal, ipsilateral, and/or rotational movement of a racket back, club, stick or ball.

In the preferred embodiment, the “Recovery” is the biomechanical process of completing the Etozi-Etakmos and returning to a biomechanical position of maximum stability, control and relational position that offers the greatest advantage to the subject. In one embodiment, the Recovery may be to stop moving in one direction and move vertically or laterally in the opposite direction. For example, in Tennis the Recovery from a one-handed forehand along the right edge of the court may be to move to back court, center or forecourt opposite the opponent with one's racket extended upwards.

In another embodiment, Recovery may include walking back to a huddle or the line of scrimmage. In still another embodiment, Recovery may be to set one's partner down on the ground or ice and to stand up and uncoil.

In the preferred embodiment, returning to the Ready position completes one Etozi-Etakmos and puts the subject into position to begin the next Etozi-Etakmos. In one embodiment, it may mean a physical stopping of activity un. In another embodiment, it may signal a shift from initiating offensive movements to fending off an opponent's or attacker's advances.

Determining Etozi-Etakmos

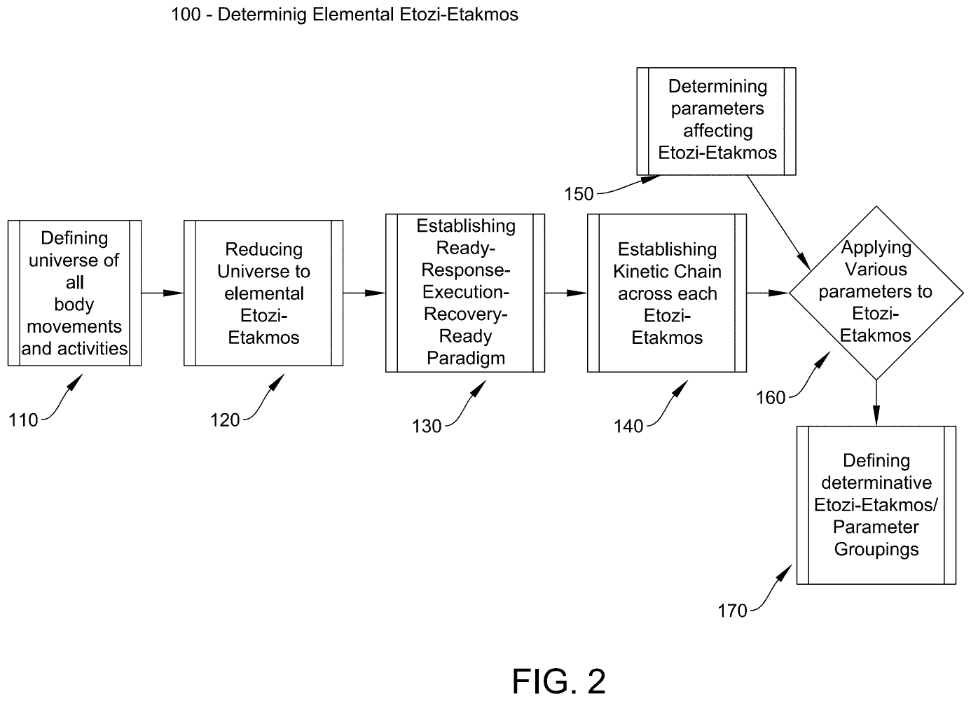

As described more fully described elsewhere in this specification, in order to rapidly, effectively and objectively teach a subject how to master the movements in a specific discipline, one must begin by defining the certain unique elemental movement that are the building blocks for said discipline or that are repeated throughout the activity. FIG. 2 provides a flowchart for the step of 100 Determining Elemental Etozi-Etakmos.

In the preferred embodiment, the step of 100 Determining Elemental Etozi-Etakmos includes the step of 110 Defining universe of all body movements and activities. Within a precision body movement or complex pattern of activity, including but not limited to, a Specific Discipline, certain normative behaviors, i.e. rules or accepted norms of behavior evolve. These include the establishment of Elemental Kinetic Chain Progressions, when and how to use these progressions. In 110 Defining universe of all body movements and activities, a highly elite performer or Education Means, defines and provides examples of all acceptable or normal body movements and patterns of activity for said Specific Discipline.

In the preferred embodiment, the step of 100 Determining Elemental Etozi-Etakmos includes the further step of 120 Reducing the universe of all body movement and activities to Elemental Etozi-Etakmos. In any activity of endeavor not all of the movements or activities area elemental. Said another way, there are certain movements that must be mastered in order to master a Specific Discipline. For any Specific Discipline these are the Elemental Etozi-Etakmos. In the inventive method, an Education Means or highly elite performer from within the Specific Discipline will define the Elemental Etozi-Etakmos relative to a Specific Discipline.

In the preferred embodiment, the step of 100 Determining Elemental Etozi-Etakmos includes the further step of 130 Establishing the Ready-Response-Execution-Recovery-Ready Paradigm for each of the Elemental Etozi-Etakmos.

In the inventive method, the analysis process begins by defining the five (5) to twenty-five (25) key or essential strokes or movements called the Elemental Etozi-Etakmos. Elemental Etozi-Etakmos is further reduced to the biomechanical and psychological subparts that make up a complete cycle of each Elemental Etozi-Etakmos. It is appreciated that the paradigm may change with the Specific Discipline or it may change by the skill level of performer.

In the preferred embodiment, the step of 100 Determining Elemental Etozi-Etakmos includes the further step of 140 Establishing the Kinetic Chain across each Etozi-Etakmos. The interaction of the muscular and skeletal components during such a process is called the kinetic chain. For every movement or stroke there is a corresponding kinetic chain: Feet—Legs—Hips—Torso; Head—Shoulders—Arm—Forearms—Wrist; etc. Kinetic chain efficiency in executing an Etozi-Etakmos requires muscular and skeletal components flow simultaneously and serially according to specific techniques. Flow and techniques vary depending on certain performance parameters of the individual conducting the activity. In order to be able to analyze for and instruct on the most efficient or effective method performing the movement, an Education Means must first define the affected kinetic chain(s). This step in the inventive chain establishes that.

In the preferred embodiment, the step of 100 Determining Elemental Etozi-Etakmos includes the further step of 150 Determining the parameters affecting Etozi-Etakmos. In any Specific Discipline, there are any number of parameters that will impact the Etozi-Etakmos of a subject. Some of those parameters are internal, some are external, and others have to do with the opponent the subject is competing against or the conditions of the event. For example, the age, intellect or maturity level of a subject may increase or decrease the affect that certain factors may have in the performance of the subject. An old adage in the sport of American football when analyzing cornerbacks is, “what he lacks in speed, he makes up for in experience.” Similarly, the age, intellect or maturity level of a subject's opponent or partner may increase or decrease the affect that certain factors may have in the performance of the subject. Other factors may include, but not be limited to height, strength, speed, quickness, balance, poise, arm span or reach, leg span or stride, weather, field/track conditions, etc. In this step of the inventive method, an Education Means or highly elite performer, defines the parameters that may affect a subject's performance.

Just as each Subject will be impacted to a greater degree by certain parameters, as will each opponent of the subject, so will each Etozi-Etakmos. In the preferred embodiment, the step of 100 Determining Elemental Etozi-Etakmos includes the further step of 160 Applying Various Parameters to Etozi-Etakmos.

In the preferred embodiment, the step of 100 Determining Elemental Etozi-Etakmos includes the further step of 170 Defining determinative Etozi-Etakmos Parameters/Parameter Groupings. It is appreciated that the result of this step may be a table, or it may be a constant that gets applied, algorithmically to the analysis. It may also materialize in the instruction from an education means to the subject on how to overcome a shortcoming or best an opponent.

Defining EmperioKine-Alysi

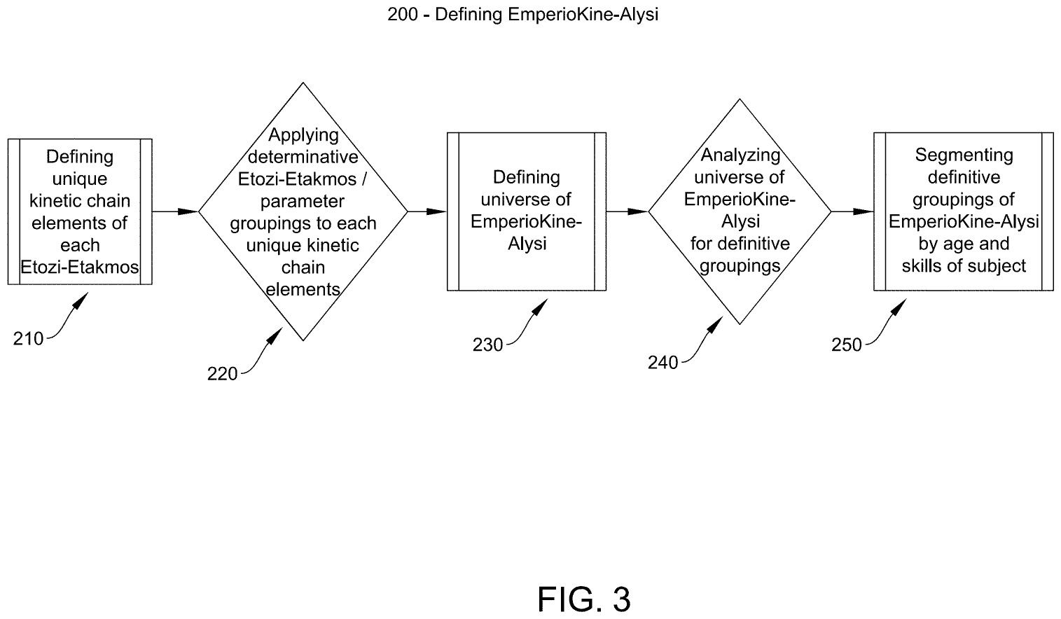

FIG. 3 provides a flowchart of the step of 200 Defining EmperioKine-Alysi for each Etozi-Etakmos. For any given movement of a subject there are degrees of efficiency. The EmperioKine-Alysi is a measure of efficiency or useful work, as opposed to wasted effort, in a subject's movement(s). This includes, but is not limited to, fluid, cohesive, efficient body loading across an activity or performance, or the flow of the kinetic chain from approach to execution to recovery. This may also include, muscle Cooperative Analysis, the interrelationship between standardized tasks featuring joint angles, spatiotemporal gait and balance metrics, and functional biomechanics, assessment of posture, organized motion such as in gait, and ranges of motion.

In the preferred embodiment, the step of 200 Defining EmperioKine-Alysi for each Etozi-Etakmos also includes the step of 210 Defining the unique kinetic chain elements of each Etozi-Etakmos. This step in the inventive method addresses flow performance, technique, and specific movements of specific body parts in the performance of the current event as well as in anticipation of the next event. Specific events include, but are not limited to, stroke, serve; Groundstroke forehand; backhand; volley; overhead smash; shot, lob; drop shot, (nage waza) throwing or unbalance an opponent, (katame waza) grappling, (ateme waza) vital-point striking; jab, cross, hook upper cut. It is appreciated that over-performance of one event may lead to inferior performance in subsequent events or in the overall performance of the Specific Discipline.

In the preferred embodiment, the step of 200 Defining EmperioKine-Alysi for each Etozi-Etakmos also includes the step of 220 Applying determinative Etozi-Etakmos parameter/parameter groupings to each unique kinetic chain elements. This inventive step assesses the movements of said key body parts within each component part of the movement along three planes of motion: i) Sagittal (forward/backward); ii) Frontal (left/right, sometimes called coronal); and, iii) Transverse (rotation) as different parameter and parameter grouping are applied.

In the preferred embodiment, the step of 200 Defining EmperioKine-Alysi for each Etozi-Etakmos also includes the further step of 230 Defining universe of EmperioKine-Alysi. For any given Specific Discipline, it is expected that certain parameters and parameter groupings will have a greater or lesser impact than others. This is particularly true for any given subject. Factoring in their age, ranking, skills, maturity and improvement potential, the universe of EmperioKine-Alysi will increase or decrease between subjects. In the inventive method, the education means can limit the universe of all available EmperioKine-Alysi to just those that will provide the greatest benefit to the subject along a Pareto distribution.

In the preferred embodiment, the step of 200 Defining EmperioKine-Alysi for each Etozi-Etakmos includes the further step of 240 Analyzing universe of EmperioKine-Alysi for definitive groupings. Similarly, in a video or digital representation of a performance of length longer than 30 minutes, there is likely to be several snippets of video that are closely aligned in movement and/or instructional value. It may be useful to be able to group these movements and video snippets together to same time during analysis or instruction and to increase educational impact.

In the preferred embodiment, the step of 200 Defining EmperioKine-Alysi for each Etozi-Etakmos includes the further step of 250 Segmenting definitive groupings of EmperioKine-Alysi by age, ranking, skills, maturity and improvement potential. As with step 240 Analyzing universe of EmperioKine-Alysi for definitive groupings, segmenting definitive groupings of EmperioKine-Alysi by age, ranking, skills, maturity and improvement potential, and additionally isolating those groups of movements having similar Kinetic Chains or similarly affected by the same parameters provides analytical as well as instructional benefits.

EmperioKine-Alysi Parameters

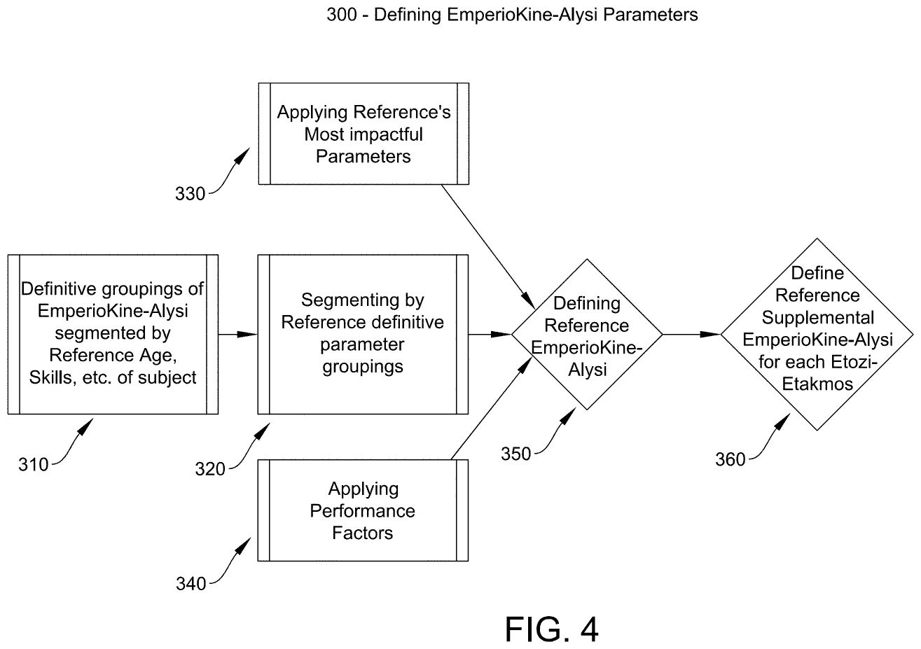

It is recognized that there is a kinetic linkage between various parts of the body and specific body movements. For example, feet, legs, and hips may be linked for certain movements. Other movements require the chest, shoulder, arm, wrist, working cohesively and in concert. As EmperioKine-Alysi is the measure of efficiency or useful work, as opposed to wasted effort, in a subject's movement(s), the preferred embodiment of the method includes FIG. 4 the step of 300 Defining EmperioKine-Alysi Parameters. In the preferred embodiment, the step of 300 Defining EmperioKine-Alysi Parameters illustrating includes the step of 310 Definitive groupings of EmperioKine-Alysi segmented by performance factors, including, but not limited to, age, ranking, maturity and improvement potential of the performer in the Pro Video(s). In a previous step, the inventive method establishes objective criteria for analyzing a subject's performance. In this step the inventive method applies these objective criteria to the video or digital representations of the Pro Video performances.

In the preferred embodiment, step 320 Segmenting by Definitive Parameter/Parameter Groupings, further applies objective criteria to the Pro Video performance(s).

In the preferred embodiment, 330 Applying most impactful parameters/parameter groupings, the inventive method segments or ranks the Pro Video performance(s) along a Pareto distribution. This provides the new and useful benefit of allowing for objective analysis of similar video snippets and digital representations similarly and can also aid in instruction by grouping similar lessons together.

In the preferred embodiment, the further step of 340 Applying Performance Factors including, but not limited to, age, ranking, skills, maturity and improvement potential of the subject allows the education means to further refine and group Etozi-Etakmos of the videos, allowing the Education Means to concentrate instruction on factors that will have the greatest and most rapid improvement of performance of the subject. One can well imagine that novice, immature or subjects with the highest potential for improvement will benefit more from certain more general education means than more experienced performers who may benefit from one small change the impacts all or the majority of the subject's movements.

The step 350 Defining Universal EmperioKine-Alysi, in the preferred method, performs an empirical analysis to define those EmperioKine-Alysi that are involved in all or the majority of the Pro Video movements. The result may be an ordered list, it may be a metatag or series of metatags appended at various points in the uploaded videos. It may also be a column in a table that is later used as part of an algorithm.

The preferred embodiment also includes the further step of 360 Defining Supplemental EmperioKine-Alysi. Supplemental EmperioKine-Alysi may occur with less periodicity or duration than Universal EmperioKine-Alysi, but they occur with enough frequency or have enough of an impact in a subject's performance that it is beneficial to analyze for and track. The results are similar to those of the Universal EmperioKine-Alysi.

Uploading and Segmenting Pro Video

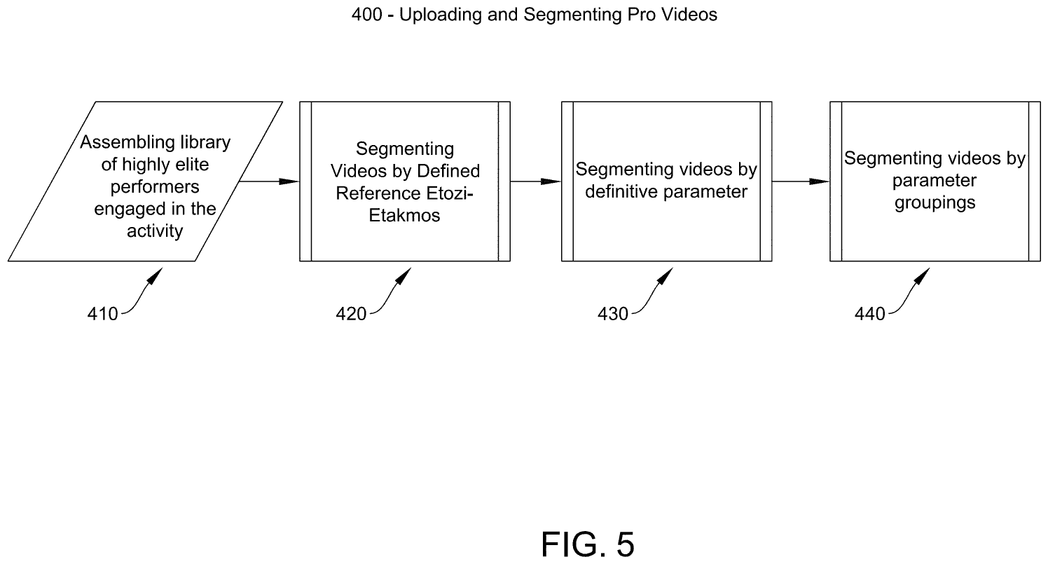

FIG. 5 provides a flowchart of the step of 400 Uploading and Segmenting Pro Videos. In the preferred embodiment, step 400 Uploading and Segmenting Pro Videos consists of applying the rules and results of the Steps 100 Determining Elemental Etozi-Etakmos; 200 Defining EmperioKine-Alysi for each Etozi-Etakmos, and 300 Defining EmperioKine-Alysi Parameters to the Pro Videos of highly elite performers. The Pro Videos serve an integral role in ensuring objective analysis of the subject's video. They ensure that the object of goal for the subject is attainable and not just theoretical. They have the additional benefit of providing an educational means of instruction that enhances the subject's attention in an inspirational manner. Comparing the performance of a novice of struggling subject to that of a highly elite performer has the novel of unanticipated benefit of inspiring the subject to perform better. In this way it acts as the converse to observer-expectancy effect and can minimize as a reference against researcher's cognitive bias. Additional analysis of the Pro Videos functions in the identical manner as the analysis of subject's video.

Defining Pro Video Etozi-Etakmos

In the preferred embodiment, step 500 Determining Reference Etozi-Etakmos consists of analyzing multiple to many performances of at least 5 to 50 highly elite performers within a Specific Discipline. In other embodiments, the analysis may include less than 5 and more than 50 highly elite performers. In still other embodiments, analysis may consist of anywhere from a couple of performances to dozens of performances of each highly elite performer. It also includes the step of analyzing the Pro Videos for all of the unique body movements, Etozi-Etakmos, depicted in the assembled videos, step 510 Defining universe of all of Reference body movements and activities. It should be understood that not all of the recorded video of a performance depicts Etozi-Etakmos. In order to improve effectiveness of later instruction, the preferred embodiment, separates out and retains only the Etozi-Etakmos from and Pro Video uploaded into the system.

Similarly, not all Etozi-Etakmos of highly elite performers is or should be referenceable. It should be recognized and understood that even highly elite performers make mistakes and fail to perform at a highly elite level at times. Step 520 Reducing Universe to Reference Elemental Etozi-Etakmos, reduces all of the Etozi-Etakmos in the reference videos to just the Elemental Etozi-Etakmos. In the preferred embodiment Elemental Etozi-Etakmos may include multiple videos of the same performer executing the same movement from multiple angles. In another embodiment, it may include one digitally enhanced the video from each of the highly-elite performers selected allowing the movements to be visualized from all viewpoints.

Step 530 Establishing Reference Ready—Response—Execution—Recovery—Ready Paradigms, defines and segments the Elemental Kinetic Chain Progression of each Elemental Etozi-Etakmos into discrete ictum. In the preferred embodiment, these movements include a biomechanical and psychological component. They address the questions of what a subject should be doing and considering as they move from one movement to another. In the preferred embodiment this is a full circle progression from a starting position, to the recognition of a need or desire to move in a certain manner, to the preparation to move, to moving, recovering from the movement and returning to a stance where a new movement can be executed.

In order to ensure that the analysis is objective, the inventive method provides an education means for analyzing a subject's mechanics and motions as they progress from the completion of one Etozi-Etakmos, or ictum or movement, up to and including the start of next Etozi-Etakmos. Each such Elemental Kinetic Chain Progression or, ictum, is further segmented into biomechanical and psychological stances that the subject transitions through in executing the Etozi-Etakmos. In the preferred embodiment these stances are subdivided along the Ready-Response-Execution-Recovery-Ready, which is based on the paradigm that each movement have a defined begging and end. In another embodiment it may be subdivided by an Execution-Recovery paradigm, where movements are combined together into stanzas or scenes.

Another step in the process, in the preferred embodiment is the step of 540 Establishing a Kinetic Chain across each Reference Etozi-Etakmos. At this point in the process all of the elemental Etozi-Etakmos have been defined and segmented into stances according to the movement paradigm. Step 540 establishes the kinetic chain at the ready, the ready, the execution, and the recovery. This may include how to stand, how to balance weight, how to hold a racket or club, where and what to look at as well as how each part of the kinetic chain moves from each step to the next. This includes the subject's mechanics and motions as they progress through each of the etozi-ectakmos, or unique elemental movements, associated with a performance or series of movement, in order for an instructor to properly and fully isolate each etozi-ectakmos and be able to play it back for the subject. In the preferred embodiment, it also considers efficient body loading across an activity or performance, or the flow of the kinetic chain from approach to execution to recovery. This is visualized and communicated by means of a vector analysis.

Vector analysis includes movement velocity, movement force, rotation, drag-step, pivot, demands, up/down, vertical, side to side, lateral, forward/backward, proximal-distal, medial lateral, Ipsilateral, contralateral, superior or inferior. It may also include analysis of specific body parts within the kinetic chain for: Flexion-Extension; Lateral Bending; Rotation; Abduction-Adduction; Internal-External Rotation; Supination-Pronation; Ulnar-Radial; Varus-Valgus; Dorsiflexion-Plantarflexion; and/or Inversion-Eversion.

Steps 550 Applying Various parameters to Reference Etozi-Etakmos; 560 Determining parameters affecting Reference Etozi-Ectakmos; and, 570 Defining Reference determinative Etozi-Etakmos/Parameter Groupings focus on analyzing how the movement's efficiency and effectiveness vary with the application of the parameters discussed in Step 150, grouping the results for application to both the Pro Videos and the Subject Videos.

Determining Subject's Etozi-Etakmos and EmperioKine-Alysis

In the preferred embodiment, the steps of 600 Uploading and Segmenting Subject Videos, 700 Determining Subject's Etozi-Etakmos; and, 800 Determining Subject's EmperioKine-Alysi Parameters follows the same general process of step 400 Uploading and Segmenting Pro Videos; 500 Determining Reference Etozi-Etakmos; and 200 Defining EmperioKine-Alysi. With the exception that the education means applies the knowledge and information gained in analyzing the Pro Videos is used to analyze and evaluate the subject's video.

Analyzing Subject's EmperioKine-Alysi Parameters Against Pro Videos

In step 900 Analyzing Subject's EmperioKine-Alysi Parameters Against Pro Videos of the preferred embodiment, annotated copies of the subject's EmperioKine-Alysis videos are matched to annotated Pro Video's depicting the same EmperioKine-Alysis.

In step 1000 Analyzing Subject's EmperioKine-Alysi Parameters Against Pro Videos of the preferred embodiment, the subject videos are analyzed against the Pro Videos selected in the proceeding step for the same or similar performance parameters, adjusted for level settings among their peer group. For example, to the extent possible a subject exhibiting a certain arm span or strength profile or quickness would be to Pro Videos depicting highly elite performers with similar arm spans or strength profiles or quickness relative to their respective peer groups.

Comparing and Contrasting Subject's Etozi-Etakmos to Pro Videos

In the preferred embodiment, the step of 1100 Comparing and Contrasting Etozi-Etakmos of annotated Subject videos to Pro Videos includes the step of 1110 breaking down each Etozi-Etakmos into component parts of the movement for each Etozi-Etakmos analyzed in Step 1000. In the preferred embodiment, the step of 1100 Comparing and Contrasting Etozi-Etakmos of annotated Subject videos to Pro Videos includes the further step of 1120 Evaluating the EmperioKine-Alysi of each component part of the movement by key body parts within each Etozi-Etakmos. In at least one embodiment, this analysis includes a vector analysis of each stance within the movement paradigm.

In the preferred embodiment, the step of 1100 Comparing and Contrasting Etozi-Etakmos of annotated Subject videos to Pro Videos includes the further step of 1130 Annotating component parts of the movement of each key body part along the relevant plane(s) of motion. In at least on embodiment, this includes a comparison of the subject's actual movements to the most efficient or effective movements as depicted in the selected and annotated Pro Videos.

In furtherance of the present invention, machine learning and other artificial intelligence methods can be applied to improve the results for the user who wants to improve his or her technique. Machine learning can be applied to analyze the kinetic form of a person performing an activity and automatically detect different phases of that form from video. One method for analyzing video in this manner relies on convolutional neural networks, but other methods may also be applied, including identification by a knowledgeable individual. Having identified the phases of performance, the individual Etozi-Etakmos can be identified and then compared to elite performers, automatically generating a score that indicates the degree of match between the two.

For example, the angular description of every articulation in a person's tennis stroke, including the articulation of the body away from the racket, such as the action of the legs, can be compared to these articulations from an elite player, and the differences recorded. This can be compartmentalized to similar strokes in different situations, such as a forehand in tennis hit when returning serve, when hitting a slow return from the baseline, when hitting a fast return from inside the baseline, and others. The invention may benefit in certain embodiments by including the option for a user to identify key elements of their body and sporting device (such as a golf club or tennis racket) in a video, as well as identifying the corresponding elements of a professional performance from another video. This allows the videos to be translated and superimposed to provide an immediate visual comparison of the two performances, highlighting the differences for the student.

The collection of differences between the performers in the given situation can be aggregated into a single overall similarity score. For example, one method to accomplish this is to compute the average deviation between each articulation taken over the performance of the stroke. Another way to accomplish this is to focus on the maximum deviation. Still another way seeks to combine the measurements of the average deviation and the maximum deviation. The specifics pertaining to the impact of a device, such as a tennis racket, golf club, baseball bat, cricket bat, on a ball or other object, can also be analyzed for similarity to the elite example case.

Furthermore, artificial intelligence can be used to automatically select elite performers for comparison. A person performing an activity has certain physical characteristics and may benefit from selecting elite performers for comparison who are similar in these physical characteristics. Artificial intelligence can assess the similarity between two persons based on height, weight, conditioning, handedness, age, and may also include physical limitations. For example, in the case of a tennis player, a person who is 5′10″, weighing 180 pounds, who is in good condition, but is 56 years old, who wants to improve his forehand but is recovering from medial elbow surgery (say, on the ulnar collateral ligament), may be best matched to an elite athlete of similar size, who is late in his or her career, and whose mechanics are identified as not putting undue stress on the ligament in question.

Artificial intelligence can be applied to describe the degree of similarity between the player wanting to improve and the elite player by way of fuzzy logic, which allows for describing matches in linguistic terms, such as “a strong match,” “a weak match,” “a poor match,” while computing with these linguistic concepts mathematically (the so-called “computing with words”).

Mental characteristics also may play a role in determining the best match for a person wanting to learn a physical activity. One way mental characteristics can affect a degree of match is based on the risk-taking propensity of the player when executing a certain performance. For example, if a tennis player is more prone to react as a counter-puncher, then in a neutral situation he or she would be more inclined to execute a series of movements that generates a higher probability for returning the ball to the opponent as compared to the inclination to have a higher probability for hitting a ball that the opponent will have a more difficult time handling. Such a counter-puncher could benefit from being matched to other elite players of the same mentality, and vice versa.

Another way mental characteristics can affect a degree of match is based on the propensity for a person to idolize or otherwise look up to an elite player. Many people have affinity for various elite players, but many people also have exactly the opposite views of those elite players. To increase motivation to learn the series of actions required to better match the elite performance, it is desirable to choose examples of elite performance from those players for whom the student has an affinity.

Machine learning and other artificial intelligence methods can also be used to assist a student in learning the progress of actions to take in a particular setting based on what the student has learned already. Lessons can be adapted to indicate similarities between individual components of different performances, reminding the student that he or she has already learned that component and needs to apply that knowledge and form in advancement of a new performance.

In addition, the invention benefits from the use of so-called gamification, in which elements of the user experience are in the form of a game, which challenges the user to achieve goals to earn benefits. These challenges may come in the form of being tested about various aspects of the sport the player is learning. For example, one challenge may come in the form of a quiz about the rules of the game. Another challenge may come in the form of trivia about the history of the sport. Another challenge may come in being asked to critique a video of another user or other player's performance to identify strengths and weaknesses with the critique then being compared to that offered by a teaching professional. Another challenge may come in the form of bringing additional users or professionals to the community associated with the invention. These are merely examples and are not intended to exhaust the possible challenges. The user can benefit in each challenge by receiving something of value, which may include merchandise, reduced subscription fees, free lessons, or opportunities to interact with professional teachers and players. Again, this list is not exhaustive but merely suggestive of the types of benefits that could be offered.

Presenting and Informing

In the preferred embodiment of the invention, the step of 1300 presenting and informing includes a summary or overview of the subject's Etozi-Etakmos viewed and/or analyzed by the Instruction Means. A method of comparing, contrasting and/or scoring the subject's strengths, weaknesses and areas needing improvement, adjusted for the subject's peer group.

For example, an analysis of a subject in the Specific Discipline of Tennis, may indicate that a 10 percent improvement in EmperioKine-Alysi of a serve would increase placement by 30 percent which would correspond to a 50 percent reduction in faults and an increase of speed of 15 percent. The result of which would be that the subject would win 93 percent of the matches and move up 5 places in their ranking.

An analysis of a subject in the Specific Discipline of Swimming, may report that a 6 percent improvement in EmperioKine-Alysi of the “flip” time would decrease overall race time by 10.8 seconds. The result of which would be that the subject would win 87 percent of their heats and move up 12 places in their ranking.

For example, an analysis of a subject in the Specific Discipline of Boxing, may indicate that a 8 percent improvement in EmperioKine-Alysi of Ready hand placement would decrease an opponent's “clean” punches by 25 percent which would correspond to a 40 percent reduction in points scored by an opponent. The result of which would be that the subject would win 66 percent of their fights and move up 12 places in their ranking.

The step of Presenting and Informing may also include a means of three-dimensional representation and visualization of the subject's actual performance as well as a simulation and prediction of likely outcome resulting from given percent improvement in each of the subject's most impactful EmperioKine-Alysi Parameters or a given percent improvement in the subject's most frequently used Elemental Etozi-Etakmos.

In one embodiment, Presenting and Informing may depict a vector analysis of the Subject's Etozi-Etakmos compared to the EmperioKine-Alysi of the same Etozi-Etakmos as depicted in one or more Pro Videos. It may also include a profile view of the Subject's Etozi-Etakmos alongside of a “straight on” view, so that the subject can see his movements as his opponent or partner views them.

Viewing the same movement from two different perspective may allow a subject to more fully visualize why the subject and his/her partner are unable to execute a move, or why an opponent is able to best the subject with little difficulty.

In another embodiment, Presenting and Informing may depict a vector analysis of the Pro Video Etozi-Etakmos from multiple perspectives.

Instruction

In the preferred embodiment of the invention, the step of 1400 Instruction includes a 1410 Educational Means provides instruction that enhances the subject's retention of the material and results in improved performance in future activities.

Examples of Educational Means include drills, techniques and repetitive motions designed to improve “muscle memory” or manual dexterity, Direct Instruction by an Educator, a Student-Centered Approach where the student is encouraged to evaluate their own performance, kinesthetic approaches, expeditionary learning, mnemonics devices and mental checklists or progression(s).

### EXAMPLES

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

### Example 1

In the preferred embodiment, a user connects to the cloud based application through a public internet. Once logged in, the user uploads or download a subject video and other required information to the system. The user then obtain the assistance of an educational means. In one embodiment, obtaining assistance of an educational means includes hiring a coach. In other embodiments, obtaining educational means includes having an AI assistant analyze a subject's video. In one embodiment assistance can be provided via split screen, or offline. In one embodiment offline refers to the user uploads a video or other information; a coach or other staff member performs some analysis or work on the information and uploads the results back to the network where the user can view it.

Analysis can be of a subject's game or performance; it may also be of a competitor's game or performance. In at least one embodiment, analysis can be of the coach/staff member's performance. In this embodiment the rating system of coaches/staff member will be less like scoring system (Yelp) and more like an aptitude test for hiring new employees. This may include a personality/aptitude profile measuring a set of predefined traits.

In the preferred embodiment, the apparatus includes tools for communicating with Other Users, Coaches/Staff; and/or the entire community within a Specific Discipline.

In at least one embodiment, the apparatus includes a means of sourcing scarce or limited resources. Said resources include; tickets and travel accommodations; selling goods and services; and, scheduling pick-up, competitions and events.

In the preferred embodiment, the education means provide analysis of videos of: known references (Pro Videos); a Subject's competitors and/or similarly ranked competitors; specific user(s) or Group of Users (a team). In at least one embodiment, Analysis is also be categorized by: Etozi-Etakmo; specific subject's videos; over a period of time (match, competition or season); level settings (age, ranking, etc.).

In the preferred embodiment, the instruction means includes providing tips for improvement; suggesting drills; conduct clinics; assist with conditioning; footwork drills and offerings; and, personal/group trainer(s).

### Example 2

In the preferred embodiment, the Analysis Process consists of defining the (7-20) key or essential Etozi-Etakmo in the Specific Discipline being studied. The analysis process also includes breaking down each Etozi-Etakmo into its component parts: i.e. Ready, Load, Execution and Follow through. In at least one embodiment, the analysis process includes defining the Kinetic Chain, including the interconnected body parts moving in unison, such as feet-legs-hips, shoulders, arm-forearms wrist-head, that are essential to mastering the Etozi-Etakmo.

In the preferred embodiment, the Educational Means assess the movements of said key body parts within each component part of the swing along three planes of motion: Saggital (forward/backward); Frontal (left/right, sometimes called coronal); and, Transverse (rotation). In this embodiment the Educational Means compares the subject's video to known reference point(s) (Pro Videos). In the preferred embodiment, known reference points include the “Pro Video Etozi-Etakmo” (ranking component); other videos of the subject (improvement component), or subject videos over the course of prolonged play (mental/psychological/physical component). The Instructional Means provides a summary of findings along with recommendations for improvement.

### Example 3

Forehand Stroke in Tennis. Ready position—hand and grip set on racquet—semi western grip racquet handle 4-10 inches from center of body or belly button whatever is comfortable tip of racquet head is elevated 20-30 degrees in ready position.

Recognition—Player sees opponents ball recognizes it is coming to their forehand

Response—pick a response stroke, i.e. forehand.

Response Position—Transverse straightens a unit turn moving torso, shoulders and arm to about a 30-45% angle across the hips and legs and the feet straighten to move to the ball. For right hander left shoulder looking over chin. Left hand can still be touching right hand or racquet in unit turn.

Loading—How far does the swing load back? If the player was in a stationary ready position as described above and rotates the torso hips and shoulder to 30-45 degree angle in unit turn and did not move their hand or arm but just let it move in sync in exactly the same position and right foot turns to the right and then from this position the player straightens moving to the ball and as they move to the ball the hand and forearm continue to load the swing back and the hand continues in the same arc and opens and transverses across the torso approximately another 45 degrees from upper arm and is still frontal of torso and racquet ends up back another 18-30 inches back behind right shoulder but frontal to right shoulder depending on their size of player and the tip of the racquet head will be in 40-50 degree angle from forearm at the height of the swing. The hand will typically be loaded in this small transverse arc to the height of area from chest to slightly above shoulder depending on high the ball is bouncing, and the wrist is in about the same angle 40-50 degrees laid back at top of the swing. Player continues to move to the ball and swing is loaded to this point and player addresses the ball with their back foot (right foot for right hander) stepped out to ball but slightly behind left foot and feet are slightly wider than hips width apart as player straightens to unload swing.

Unloading—The left hand and arm straightens to spread out and forward to the oncoming ball as player moves toward ball and gets ready to address and hit the ball the transverse arc of the right hand and the racquet keep moving in a Sagittal motion backwards and as the hand passes the shoulder in a sagittal motion but still frontal of torso and the tip of the racquet is typically slightly higher than players top of their head this is the apex of the swing but almost always between the top of the shoulder and top of the head. Ultimately before the hit the left hand and shoulder are stretched out at an approximately a 45 degree angle to the ball, left shoulder at this point player measures and see ball through the left fingers and will want to make contact in front of the body at the point in front of left hand stretched out.

At top of the swing of the transverse arc of the hand and racquet the arm straightens to unload the swing and straightens the downward sagittal drop stretching the arm and hand down and back and as it does this the arm drops and comfortably lengthens out behind and frontal to the right hip on the drop—racquet head below the ball with the wrist laid back and dropped down before the swing straightens the forward motion the right foot and leg presses into the ground releasing the right hip to let the hip rotate and open frontal to the right with a slight lag and the stored up Kinetic energy now straightens to release and the left side of torso straightens to open up transversely across the hips and left arm straightens to release (balancing that release with the timing of the swing coming through) with the swing and dropped wrist laid back and now right at the bottom of the drop when arm is straight there is a huge centrifugal force that is created with the swing and the hitting wrist bends back further to about 75-90 Degrees before straightening the forward motion of the swing.

Follow through—motion all this centrifugal force was created in “ACE Kinesis” steps described above and now in the uncoiling of chain reaction is being released and the swing is gaining speed and momentum with good relaxed acceleration of arm then the shoulder bringing the swing through the shot wrist laid back at contact pressing against the strings and through the plane of the ball right shoulder uses this centrifugal force to bring the swing through the hit and stretches through the hit pressing with the wrist through the plane of the ball to stay on the hit (the goal typically is for max speed and control) while the swing and right shoulder straightens to transverse across the body in the extension of the hit in an arc as and now around and through the ball coming up and over the ball releasing with right shoulder transversely unloading the swing right to left across the body and left shoulder with swing ending behind left shoulder arm and wrist completely relaxed.

There is choice between the combinations of Power versus control and spin. More spin more possible control however if the release with the forearm and wrist transverse across the body at steeper and steeper angles this will result in less power and control. Staying through the plane of the hit longer will increase your penetration of the shot. One can learn to vary the spin by practicing more or less through the plane of the hit and how quickly the forearm & wrist moves up and off the ball versus staying through the plane of hit longer. Traversing the arm and forearm across the body at steeper angle up and through the hit will allow the player to use more wrist brush and spin as it moves centrifugally through, he hit.

Recovery—after the release follow through—analyze your opponent's movement to either cut the angles down and move to an advantageous position in the court to cut off the angles of the next shot or if in the backcourt move back to the middle of the court traversing sideways in a like a light skip hop left foot right foot not crossing over or right foot left foot depending on the direction you are going until you are back in the middle. Knees slightly bent on the move back to the middle of the court at the baseline while your eyes are always on your opponent and reacting to the ball off of his strings. Either on it or up to 8 feet behind the baseline depending on your style of play. Always keep your feet lightly moving on the baseline one against the other like a light jumping rope alternating foot while you are waiting for your opponent to strike the ball so you can go after this shot properly and be positioned to get to it as early as you can; unless you are playing defense.

### Example 4

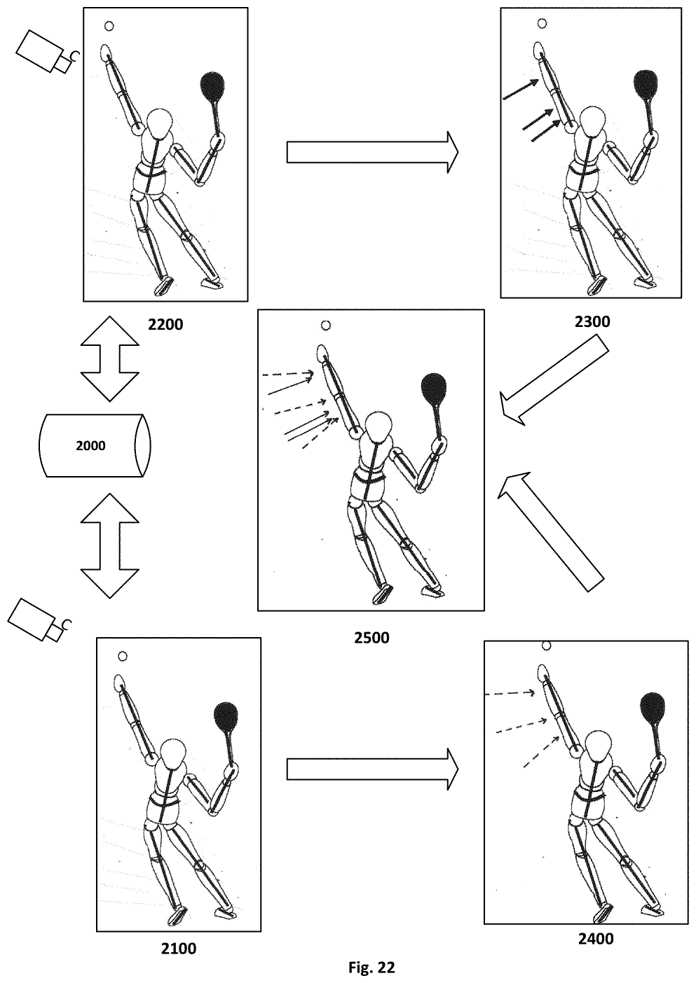

A specific implementation of the disclosed method is described in connection with this Example 4 and FIG. 22. In this example, a video instruction is provided to a tennis student. It is understood, however, that this same video instruction can be applied to any of a wide variety of sports. In each instance, the video instruction is based upon an analysis of the body movements of the student.

Example 4 involves maintaining a database 2000 of reference videos. One such video is represented by 2100 in FIG. 22. The reference videos may be, for example, videos of various professional tennis players. Alternatively, they may be video of non-professional but otherwise highly performing, skillful tennis players. In either event, the objective is to have a catalogue of ideal tennis motions upon which to make comparisons. In each case, the reference videos include tennis players performing one or more tennis actions. As used herein, “tennis actions” is a purposefully broad term including service motions, ready positions, backhands, forehands, lobs, volleys, etc. Each sport will have a corresponding set of athletic motions.

Next, a video of the student is taken. The video ideally captures the student performing one or more different tennis actions. One such a video is illustrated in FIG. 22 at 2200. These videos can be made while the student is playing a match or are otherwise unaware that they are being recorded. These student videos can be uploaded into the same database 2000 as the reference videos. The goal is to maintain all the reference and student videos in a manner that allows them to be easily access and edited.

Next, the student videos 2200 are reviewed and analyzed. This involves locating and isolating a specific tennis action from the one or more recorded tennis actions. The specific tennis action being isolated may depend, for instance, upon which aspect of the student's game is being coached. The tennis action depicted in 2200 is a serve. This isolated tennis action is thereafter segmented. Segmentation may involve playing the video at a reduced speed (i.e. in slow motion) and breaking down the specific tennis action into a series of elemental body movements. These elemental body movements are the above described Etozi-Etakmos.

Thereafter, the student video is edited and annotated. This annotation is shown in FIG. 22 as 2300. Specifically, for each elemental body movement and annotation is provided. In one embodiment, these annotations take the form of arrows, with each arrow reflecting a vector associated with an elemental body movement. In other words, the video is edited to vectorize the associated elemental body movement.

This same editing process is then carried out relative to a corresponding reference video 2100. More specifically, the database of reference videos is reviewed and a comparison video is selected. This selection may be done, for example, on the basis of the student's age, size, experience level, or physical limitations. One a comparison video is selected, it is analyzed to isolate a corresponding tennis motion. This tennis motion, in turn, is segmented into a series of elemental body movements. The elemental body movements from the reference video correspond to the elemental body movements of the student video. The comparison video is then edited to provide an annotation for each of the corresponding elemental body movements. This annotation is shown as 2400 in FIG. 22. Again, in one embodiment, these annotations take the form of arrows, with each arrow reflecting a vector associated with the corresponding elemental body movement.

In the next step, a video overlay is created. This overlay is depicted as 2500 in FIG. 22. This is done by placing the edited student video over top of the edited reference video. This overlay allows the associated annotations to be compared. The differences, if any, between the annotations of the two videos can thereafter be assigned a similarity score.

### OTHER EMBODIMENTS

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. A method of analyzing the body movements of an athlete, the method comprising:
taking a video of the athlete performing an action;
reviewing the athlete video and segmenting the video of the action into a series of elemental body movements;
editing the athlete video to provide an annotation for each elemental body movement;
providing instruction to the athlete based upon the annotations in the edited athlete video.

2. The method as described in claim 1 wherein the annotation involves assigning a vector to each of the elemental body movements.

3. The method as described claim 1 further comprising the step of comparing the edited athlete video to a corresponding video of a professional athlete.

4. The method as described in claim 1 further comprising the step of locating a reference video and segmenting the reference video into a series of elemental body movements.

5. The method as described in claim 4 comprising the further step of editing the reference video to provide an annotation for each elemental body movement.

6. The method as described in claim 5 comprising the further step of creating a video overlay of the edited athlete and reference videos.

7. The method as described in claim 6 comprising the further step of analyzing the differences in the annotations between the athlete and reference videos.

8. The method as described in claim 7 comprising the further step of calculating a score based upon the differences.

9. The method as described in claim 1 wherein the action is a tennis action.

10. The method as described in claim 1 wherein the action is a boxing action.

11. The method as described in claim 1 wherein the action is a ballet action.

12. The method as described in claim 1 wherein the action is a martial art.

13. The method as described in claim 1 wherein the action is an exercise.

14. The method as described in claim 1 wherein the action is moving heavy objects.

15. A method of providing video instruction to a student in the game of tennis, the instruction based upon an analysis of the student's body movements, the method comprising:
maintaining a database of reference videos of professional tennis players, the reference videos including professional tennis players performing one or more tennis actions;
taking a video of the student performing one or more tennis actions, uploading the student video into the database;
reviewing the student video and analyzing a specific tennis action from the one or more tennis actions, segmenting the video of the specific tennis action into a series of elemental body movements;
editing the student video to provide an annotation for each elemental body movement, the annotations taking the form of arrows, with each arrow reflecting a vector associated with an elemental body movement;
reviewing the database of reference videos and selecting a comparison video, isolating within the comparison video a series of elemental body movements that correspond with the elemental body movements of the student;
editing the comparison video to provide an annotation for each of the corresponding elemental body movements, the annotations taking the form of arrows, with each arrow reflecting a vector associated with a corresponding elemental body movement;
creating a video overlay of the edited student and comparison videos, calculating the differences in the annotations and assigning a similarity score based upon the calculations.

16. A method of comparing the body movements of two athletes, the method comprising:
taking a video of a first athlete performing an athletic motion;
reviewing the first athlete video and segmenting the athletic motion into a series of elemental body movements;
editing the first athlete video to provide an annotation for each elemental body movement;
taking a video of a second athlete performing an athletic motion, the athletic motions of the first and second athletes being the same;
reviewing the second athlete video and segmenting the athletic motion into a series of elemental body movements;
editing the second athlete video to provide an annotation for each elemental body movement;
comparing the annotations in the first and second athlete videos and providing instruction based upon any differences.
